(19) United States
(12) Patent Application Publication
(10) Pub. No.: US 2023/0409707 A1
(43) Pub. Date: Dec. 21, 2023

(54) STORAGE SYSTEM AND UNAUTHORIZED ACCESS DETECTION METHOD

(71) Applicant: Hitachi, Ltd., Tokyo (JP)

(72) Inventors: Shabin XU, Tokyo (JP); Masakazu KOBAYASHI, Tokyo (JP); Akihito MIYAZAWA, Tokyo (JP)

(73) Assignee: Hitachi, Ltd., Tokyo (JP)

(21) Appl. No.: 18/172,513

(22) Filed: Feb. 22, 2023

(30) Foreign Application Priority Data
Jun. 16, 2022 (JP) 2022-097680

(51) Int. Cl. G06F 21/55; G06F 21/56

(52) U.S. Cl. CPC G06F 21/554; G06F 21/564; G06F 21/566

(57) ABSTRACT

A storage system controller executes an abnormal behavior detection process including at least one of: a first abnormal behavior detection process that detects that the first parameter is smaller than a first threshold parameter as an abnormal behavior; a second abnormal behavior detection process that detects that the second parameter is greater than a second threshold parameter as the abnormal behavior; and a third abnormal behavior detection process that detects that the third parameter is smaller than a third threshold parameter as the abnormal behavior.

### BACKGROUND OF THE INVENTION

### 1. Field of the Invention

This invention relates to a storage system and an unauthorized access detection method.

### 2. Description of the Related Art

Conventional cyber attacks by ransomware encrypt data, render it unusable, and demand a ransom to restore it. With this type of the ransomware, data can be restored without the need to pay a ransom by obtaining a backup prior to encryption.

On the other hand, recent ransomware, in addition to the conventional methods, tends to conduct data theft in advance before encrypting data, threaten to disclose the stolen data, and demand a ransom in addition. In order to counter such ransomware, early detection at the stage of data theft is necessary.

The conventional technologies related to the present invention are disclosed by Patent Document 1 (WO 2019/073720) and Patent Document 2 (Japanese Patent Application Laid-Open No. 2020-201703). Patent Document 1 discloses a ransomware detection method executed by a computer. This ransomware detection method periodically monitors file access logs. If the frequency of file accesses typically performed by ransomware among the records of authorized file accesses exceeds a predetermined threshold, the ransomware detection method determines that there is a possibility of a ransomware attack and takes countermeasures. Countermeasures include sending a command to the file access control means to block file access.

Patent document 2 discloses a storage system with a first volume provided to the host and a second volume that stores backup data or snapshot images of the first volume.

The storage system controller periodically acquires backup data or snapshot images in the first volume at predetermined intervals and acquires monitoring information including host access information and volume usage capacity in the first volume.

The controller uses the acquired monitoring information to set a steady state for normal use of the first volume, and detects access behavior in the volume that deviates from the set steady state.

In the conventional technology (refer to Patent Document 1), when unauthorized access by ransomware stops security software, programs, and log generation on the client OS, it can occur that ransomware cannot be detected.

The conventional technology (Patent Document 2) detects unauthorized data encryption and cannot detect unauthorized access at the time of data theft in the storage system (storage layer), and thus cannot respond to data theft executed before unauthorized data encryption, which is a recent trend of the ransomware.

### SUMMARY OF THE INVENTION

The present invention has been made to solve the above problems. That is, one of the purposes of the present invention is to provide a storage system and an unauthorized access detection method that can detect unauthorized access at the data theft stage prior to data encryption by ransomware at the storage layer even when the client OS has lost control.

In order to solve the above problem, the present storage system includes a controller and a cache that caches data. The present storage system provides multiple volumes to one or more computers. The controller is configured to execute an abnormal behavior detection process including at least one of: a first abnormal behavior detection process that obtains a first parameter based on a cache hit rate of the volume within a predetermined sampling interval and detects that the first parameter is smaller than a first threshold parameter as an abnormal behavior; a second abnormal behavior detection process that obtains a second parameter based on a server cache occupancy rate of the server associated with the volume within the predetermined sampling interval and detects that the second parameter is greater than a second threshold parameter as the abnormal behavior; and a third abnormal behavior detection process that obtains a third parameter based on a data access speed of the volume within the predetermined sampling interval and detects that the third parameter is smaller than a third threshold parameter as the abnormal behavior.

The present method detects unauthorized access in a storage system that includes a controller and a cache that caches data and provides multiple volumes to one or more computers. The method is executed by the controlled. The method includes: executing an abnormal behavior detection including at least one of: a first abnormal behavior detection that obtains a first parameter based on the cache hit rate of the volume within a predetermined sampling interval and detects that the first parameter is smaller than a first threshold parameter as an abnormal behavior; a second abnormal behavior detection that obtains a second parameter based on the server cache occupancy rate of the server associated with the volume within the predetermined sampling interval and detects that the second parameter is greater than a second threshold parameter as the abnormal behavior; and a third abnormal behavior detection that obtains a third parameter based on the data access speed of the volume within the predetermined sampling interval and detects that the third parameter is smaller than a third threshold parameter as the abnormal behavior.

According to this invention, even when the client OS is no longer under control, the storage layer can detect unauthorized access at the data theft stage prior to data encryption by ransomware.

### BRIEF DESCRIPTION OF DRAWINGS

FIG. 1 is a schematic diagram showing an example of a storage system configuration for an embodiment of the present invention.

FIG. 2 illustrates the initial parameter table.

FIG. 3 illustrates the cache hit rate accumulation table.

FIG. 4 illustrates the cache occupancy accumulation table.

FIG. 5 illustrates the data access rate accumulation table.

FIG. 6 illustrates the IOPS accumulation table.

FIG. 7 illustrates the monitoring interval table.

FIG. 8 illustrates the threshold table.

FIG. 9 illustrates the volume-server relationship table.

FIG. 10A illustrates detection perspective 1.

FIG. 10B illustrates detection perspective 1.

FIG. 11A illustrates detection perspective 2.

FIG. 11B illustrates detection perspective 2.

FIG. 12 illustrates detection perspective 3.

FIG. 13 is a flowchart showing the processing flow to illustrate the overall process flow executed by the storage system.

FIG. 14 is a flowchart showing the processing flow executed by the initial setting change program.

FIG. 15 is a flowchart showing the processing flow executed by the data storage program.

FIG. 16A is a flowchart showing the processing flow executed by the volume cache hit rate monitoring program.

FIG. 16B illustrates a specific example to facilitate understanding of the processing flow in FIG. 16A.

FIG. 17A is a flowchart showing the processing flow executed by the server cache occupancy monitoring program.

FIG. 17B illustrates a specific example to facilitate understanding of the processing flow in FIG. 17A.

FIG. 18A is a flowchart showing the processing flow executed by the data access speed monitoring program.

FIG. 18B illustrates a specific example to facilitate understanding of the processing flow in FIG. 18A.

FIG. 19A is a flowchart showing the processing flow executed by the threshold feedback program.

FIG. 19B illustrates a specific example to facilitate understanding of the processing flow in FIG. 19A.

FIG. 20A is a flowchart showing the processing flow executed by the monitoring interval feedback program.

FIG. 20B is a diagram to facilitate understanding of the processing flow in FIG. 20A.

FIG. 21A is a flowchart showing the processing flow executed by the ransomware determination program (cache hit rate perspective).

FIG. 21B illustrates a specific example to facilitate understanding of the processing flow in FIG. 21A.

FIG. 22A is a flowchart showing the processing flow executed by the ransomware determination program (data access speed perspective).

FIG. 22B illustrates a specific example to facilitate understanding of the processing flow in FIG. 22A.

### DETAILED DESCRIPTION

An embodiment of the present invention is described below with reference to the drawings. In all figures of the embodiment, identical or corresponding parts may be marked with the same symbol.

In the following explanations, expressions such as “identification number” are used when describing identification information, but may be replaced by identification information other than these (e.g., names, etc.). In the following explanation, the program or functional block may be used as the subject to explain the process, but the subject of the process may be the controller or CPU instead of the functional block. In the following descriptions, various types of information may be described using expressions such as “table” and “record,” but various types of information may be expressed in data structures other than these.

### Embodiment

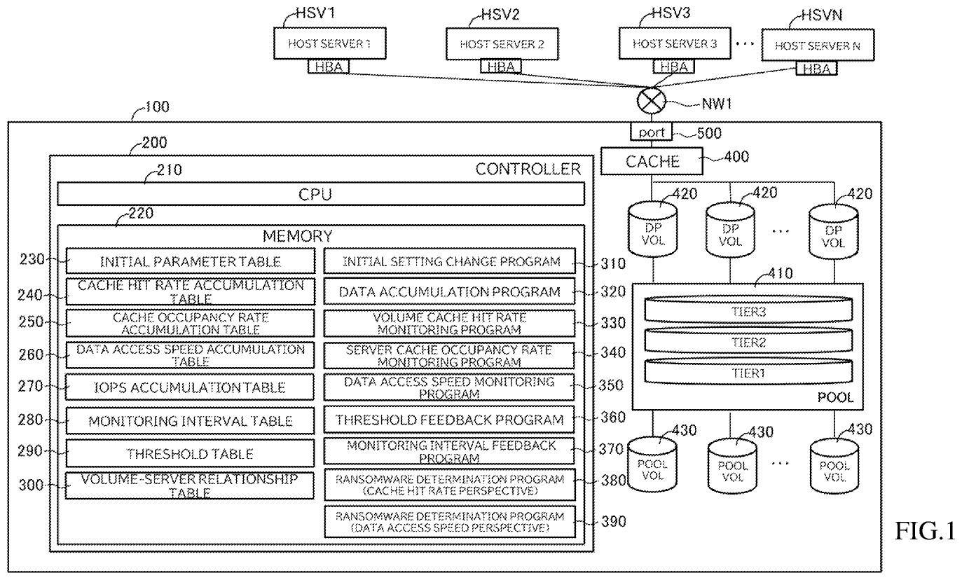

FIG. 1 is a schematic diagram showing an example configuration of a system including a storage system 100 according to an embodiment of the present invention. As shown in FIG. 1, the system includes the storage system 100 and a plurality (N (N≥4 or more in this example)) of host servers (1) HSV1 through (N) HSVN.

It should be noted that the host server (1) HSV1 through the host server (N) HSVN are referred to as the “host server HSV” when there is no need to distinguish between them. The host server HSV may also be referred to simply as a server. There may be only one host server HSVN. The storage system 100 and the host server HSV are connected via the network NW1 to send and receive data (information).

The storage system 100 includes a controller 200. The controller 200 is a device in which the software necessary to provide the host server HSV with functions as storage is implemented.

The controller 200 includes a CPU 210 and a memory 220. The CPU 210 is the hardware that controls the overall operation of the controller 200. The CPU 210 responds to read and write commands, which are I/O requests given by the host server HSV via a port 500, to read and write data.

The memory 220 consists of semiconductor memory, such as SDRAM (Synchronous Dynamic Random Access Memory), for example, and is used to store (hold and store) various programs and data.

The memory 220 is the main memory of the CPU 210 and stores programs executed by the CPU 210 and various tables and other items that are referenced by the CPU 210, as described below.

The memory 220 stores an initial parameter table 230, a cache hit rate accumulation table 240, a cache occupancy rate accumulation table 250, a data access speed accumulation table 260, an IOPS accumulation table 270, a monitoring interval table 280, a threshold table 290, and a volume-Server Relationship Table 300 is stored. The details of these tables are described later.

The memory 220 stores an initial setting change program 310, a data accumulation program 320, a volume cache hit rate monitoring program 330, a server cache occupancy rate monitoring program 340, a data access speed monitoring program 350, a threshold feedback program 360, a monitoring interval feedback program 370, a ransomware determination program (cache hit rate perspective) 380, and a ransomware determination program (data access speed perspective) 390 are stored. The details of these programs will be explained later. These programs are executed by the CPU 210.

The storage system 100 includes a cache 400, a pool 410, a DP volume 420, and a pool volume 430. The cache 400 is a fast-accessible memory for temporarily storing data. The cache 400 is provided to improve the throughput and response of I/O processing of the storage system 100.

The pool 410 is composed of multiple pool volumes 430 (real volumes), which are logical storage areas provided by each storage device, such as SDD (Solid State Drive), HDD (Hard Disk Drive), and flash memory, provided by the storage system 100. For example, the pool 410 is composed of a mixture of fast storage devices (e.g., FMD (Flash Module Drive), SSD, FC drive, SAS drive, etc.) and slow storage devices (e.g., SATA drive, etc.). Storage areas are managed by dividing them into multiple tiers (Tier N (N is an integer greater than or equal to 2)) according to the responsiveness of the corresponding storage devices. In this example, the data is managed by dividing it into three tiers: Tier1 (tier1), Tier2 (tier2), and Tier3 (tier3). Data is automatically placed in a tier according to the frequency of access to the data. For example, data with high access frequency is automatically placed in a higher tier, and data with low access frequency is automatically placed in a lower tier.

The plurality of DP volumes 420 are virtual logical volumes defined in the storage system 100 and provided to the host server HSV. The DP volumes 420 are logical storage areas recognized by the host server HSV and are the storage areas to which read/write requests from the host server HSV are issued.

The DP Volume 420 is allocated to the host server HSV. The controller 200 effectively uses each storage device, which is a storage resource, by using the real space (the pool volume 430) in response to the writing of data to the DP volume 420 by the host server HSV.

The host server HSV is a computer (server device) that issues I/O requests. The host server HSV may be a physical or virtual computer. The host server HSV is equipped with an HBA (host bus adapter). The host server HSV is connected to the port 500 of the storage system 100 via the HBA and network NW1.

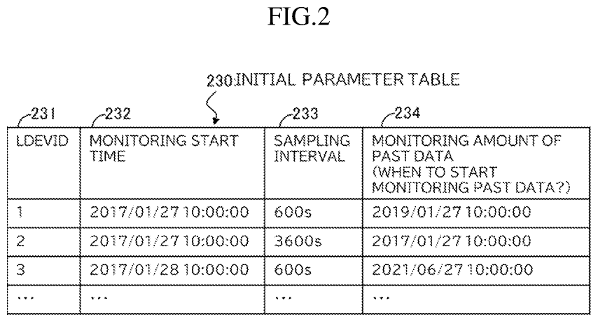

FIG. 2 illustrates the initial parameter table 230. As shown in FIG. 2, the initial parameter table 230 contains the columns (columns) that store information (values), including a LdevId 231, a monitoring start time 232, a sampling interval 233, a monitoring amount of past data 234. In the initial parameter table 230, the information corresponding to each column regarding data monitoring is associated with each other and stored as row units of information (records). Specifically, the LdevId 231 contains an identification number to identify the LDEV (the DP Volume 420).

The monitoring start time 232 stores the time at which the monitoring starts. For default values, the monitoring start time 232 stores, for example, the time when the LDEV was created, or a value designed by the system designer or software designer. The sampling interval 233 contains the sampling interval of the monitoring. For the default value, the sampling interval 233 stores the value designed by the system designer or software designer. The monitoring amount of past data 234 contains information for identifying the monitoring amount of past data. In this example, the monitoring amount of past data at 234 stores the start time of the range of past data to look at.

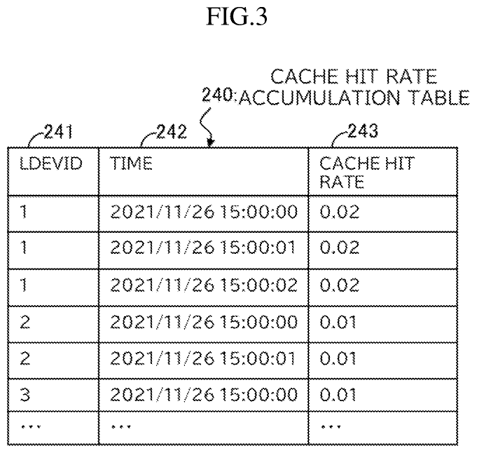

FIG. 3 illustrates the cache hit rate accumulation table 240. As shown in FIG. 3, the cache hit rate accumulation table 240 includes a LdevId 241, a time 242, and a cache hit rate 243 as columns (columns) that store information (values). In the cache hit rate accumulation table 240, the information corresponding to each column regarding the cache hit rate is associated with each other and stored as information (records) in row units. Specifically, in the LdevId 241, an identification number for identifying LDEV (the DP Volume 420) is stored. The time 242 contains the time when the cache hit rate was detected. In the cache hit rate 243, the cache hit rate is stored. The “cache hit rate” is the probability of a cache hit. A “cache hit” means that data to be written or read is found when the cache 400 is accessed.

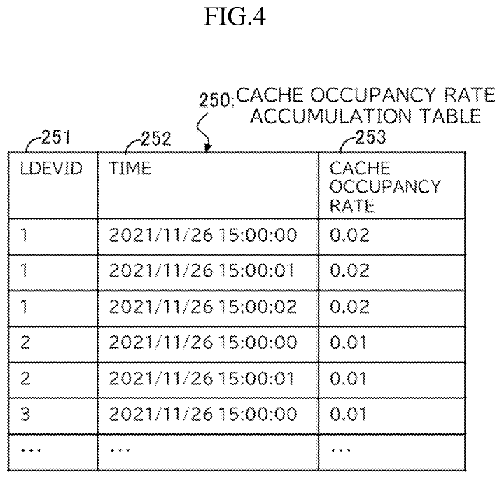

FIG. 4 illustrates the cache occupancy rate accumulation table 250. As shown in FIG. 4, the cache occupancy rate accumulation table 250 includes a LdevId 251, a time 252, and a cache occupancy rate 253 as columns (columns) for storing information (values). In the cache occupancy rate accumulation table 250, the information corresponding to each column regarding the cache occupancy rate is associated with each other and stored as information (records) in row units. Specifically, in the LdevId 251, an identification number for identifying LDEV (the DP volume 420) is stored. The time 252 contains the time when the cache occupancy rate was detected. In the cache occupancy rate 253, the cache occupancy rate is stored. The cache occupancy rate is the rate of the capacity of the cache 400 allocated to the volume to the capacity of the cache 400.

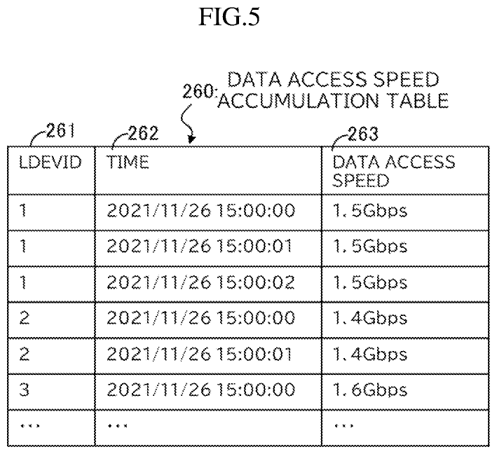

FIG. 5 illustrates the data access speed accumulation table 260. As shown in FIG. 5, the data access speed accumulation table 260 includes a LdevId 261, a time 262, and a data access speed 263 as columns (columns) that store information (values). In the data access speed accumulation table 260, the information corresponding to each column regarding the data access speed is associated with each other and stored as information (records) in row units. Specifically, The LdevId 261 contains an identification number to identify LDEV (the DP Volume 420). The time 262 contains the time when the data access speed was detected. The data access speed 263 contains the access speed to the data (data access speed).

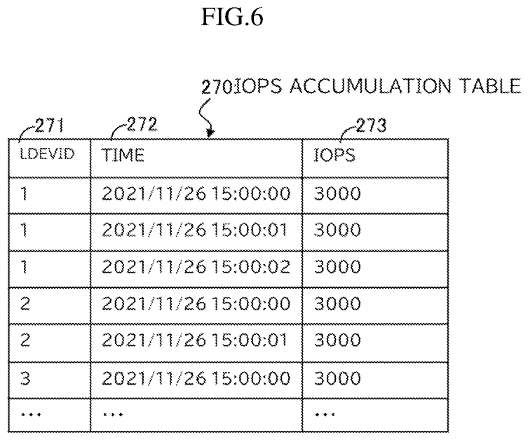

FIG. 6 illustrates the IOPS accumulation table 270. The IOPS accumulation table 270 contains information in row units (records), where the information corresponding to each column regarding IOPS is associated with each other. Specifically, a LdevId 271 contains an identification number for identifying LDEV (the DP Volume 420). A time 272 contains the time when IOPS (Input/Output Per Second) was detected. An IOPS 273 contains the IOPS. IOPS is the number of I/O accesses that the storage can handle per second.

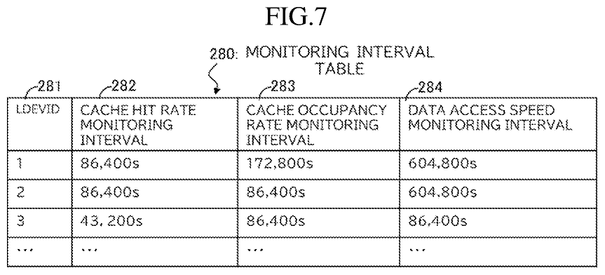

FIG. 7 illustrates the monitoring interval table 280. As shown in FIG. 7, the monitoring interval table 280 includes a LdevId 281, a cache hit rate monitoring interval 282, a cache occupancy rate monitoring interval 283, and a data access speed monitoring interval 284 as columns (columns) to store information (values). In the monitoring interval table 280, the information corresponding to each column regarding the monitoring interval is associated with each other and stored as information (records) in row units. Specifically, the LdevId 281 contains an identification number for identifying LDEV (the DP Volume 420). The cache hit rate monitoring interval 282 contains a time indicating the cache hit rate monitoring interval. The cache occupancy rate monitoring interval 283 contains a time indicating the cache occupancy rate monitoring interval. The access speed to the data access speed monitoring interval 284 contains a time indicating the access speed to data monitoring interval.

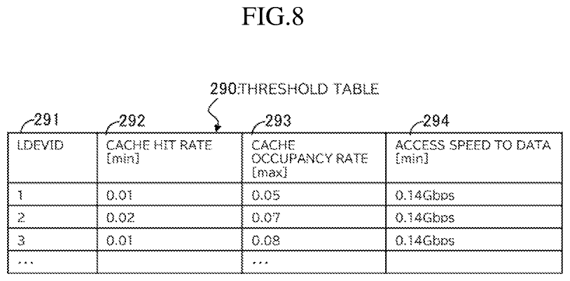

FIG. 8 illustrates the threshold table 290. As shown in FIG. 8, the threshold table 290 includes a LdevId 291, a cache hit rate 292, a cache occupancy rate 293, and an access speed to data 294 as columns (columns) that store information (values). In the threshold table 290, information corresponding to each column regarding threshold values is associated with each other and stored as row-by-row information (records). Specifically, the LdevId 291 contains an identification number to identify the LDEV (the DP Volume 420). The cache hit rate 292 contains the threshold cache hit rate. The cache occupancy rate 293 contains the threshold cache occupancy rate. The access speed to data 294 contains the threshold access speed.

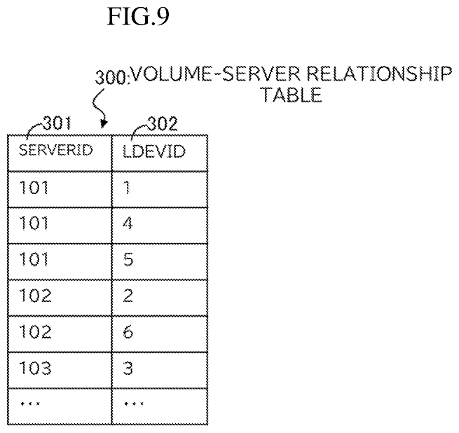

FIG. 9 illustrates the volume-server relationship table 300. As shown in FIG. 9, the volume-server relationship table 300 contains a ServerId 301 and a LdevId 302 as columns (columns) that store information (values). In the volume-server relationship table 300, the information corresponding to each column regarding the relationship between the volume and the server is associated with each other and stored as information (records) in row units. Specifically, the serverId 301 contains an identification number to identify the host server HSV. The LdevId 302 contains an identification number to identify LDEV (the DP volume 420).

<Overview>

The storage system 100 according to the embodiment of the present invention detects unauthorized access by ransomware. First, to facilitate understanding of the present invention, detection perspectives 1 through 3, which are used by the storage system 100 to detect unauthorized access by ransomware, are described.

(Detection Perspective 1)

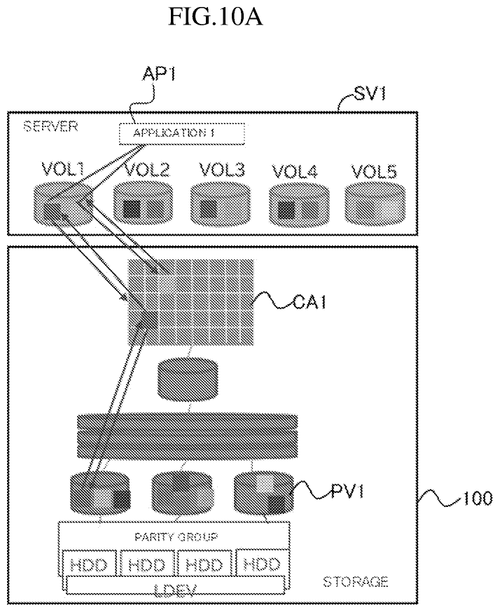

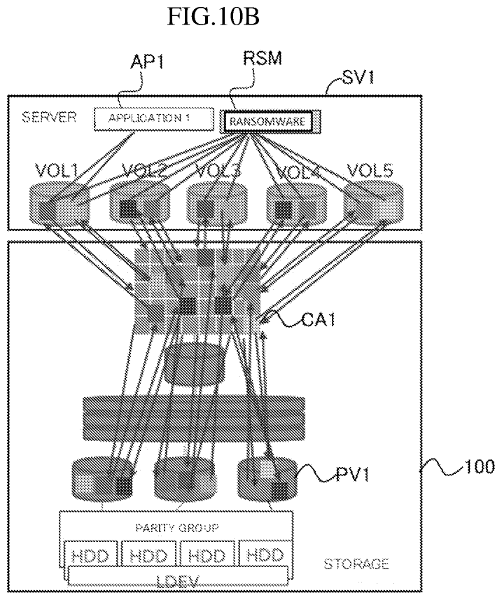

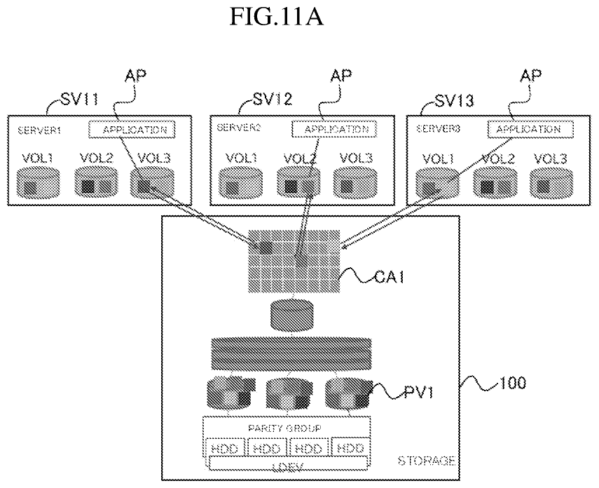

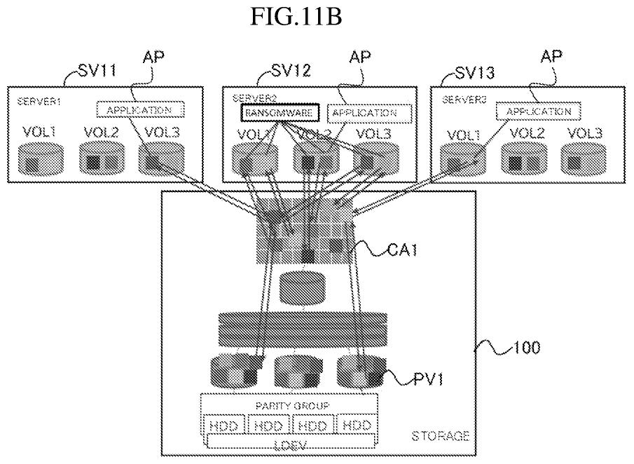

FIG. 10A and FIG. 10B are schematic diagrams of a system to illustrate detection perspective 1. The system includes a server SV1 and the storage system 100. FIG. 10A shows the data reference state of application 1 in normal operation of the server SV1, and FIG. 10B shows the data reference state of the server SV1 infected with ransomware RSM. FIG. 10A and FIG. 10B, the server SV1 corresponds to the host server HSV, and VOL1 through VOL5 correspond to the DP volume 420, a virtual volume assigned to the server SV1. A cache CA1 corresponds to the cache 400 and a volume PV1 corresponds to the pool volume 430 (also in FIG. 11A and FIG. 11B). The arrows indicate the source and destination (reference source and reference destination) of the data (also in FIG. 11A and FIG. 11B.)

As shown in FIG. 10A, in normal operation, it is unlikely that one application 1 AP1 in the server SV1 always refers to all data in VOL1 through VOL5 of the corresponding the server SV1. For example, in normal operation in the system that is running stably, the application 1 AP1 in the server SV1 always refers to VOL1.

In contrast, as shown in FIG. 10B, when the server SV1 is infected with the ransomware RSM, data theft by the ransomware RSM accesses a large amount of data. For example, the ransomware RSM refers to all of VOL1 through VOL5. Furthermore, the ransomware RSM refers to almost all data in each of VOL1 through VOL5. Since there is a limit to the amount of data that cache CA1 can temporarily hold, the cache hit rate per volume is reduced.

Thus, it can be seen that the cache hit rate per volume is steady in normal operation, and that the cache hit rate per volume tends to decrease when the server SV1 is infected with the ransomware RSM, compared to normal operation.

(Detection Perspective 2)

FIG. 11A and FIG. 11B are schematic diagrams of a system to illustrate detection perspective 2.
The system includes a server (1) SV11 through a server (3) SV13. FIG. 11A shows the data reference state of the application in normal operation of the server (1) SV11 through the server (3) SV13, and FIG. 11B shows the data reference state of a server (2) SV12 infected with the ransomware.

As shown in FIG. 11A, it is unlikely that only one of the servers (1) SV11 through (3) SV13 always occupies a large amount of the cache CA1 in normal operation. For example, in normal operation of the system in stable operation, the server (1) SV11, the server (2) SV12, and the server (3) SV13 occupy the cache CA1 in the amount of 1:1:1.

In contrast, as shown in FIG. 11B, when the server (2) SV12 is infected with the ransomware RSM, a large amount of data is illegally accessed through data theft by ransomware RSM. For example, the server (2) SV12 infected by the ransomware RSM generates a lot of data R/W and rapidly increases its occupation of the cache CA1.

Thus, it can be seen that in normal operation, the cache occupancy rate of each server is steady, and in the state infected with the ransomware RSM, the cache occupancy rate of the server (2) SV12 infiltrated by the ransomware RSM tends to increase compared to normal operation.

(Detection Perspective 3)

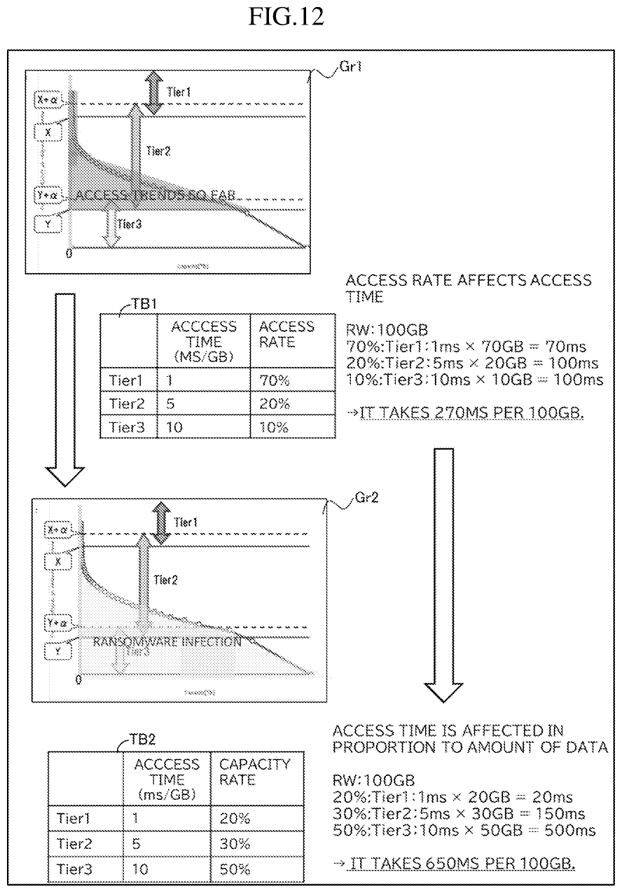

FIG. 12 illustrates detection perspective 3. In the storage system 100, as described above, the hierarchical optimization function analyzes the access frequency in normal operation, and data is placed in Tiers so that the average access time is shortened. For example, data that is usually accessed frequently is placed in Tier 1 and Tier 2. Data that is rarely accessed is placed in Tier 3. In normal operation, the access speed to data is fast because the access time of data is shortened by the tier optimization function.

For example, as shown in Table TB1, in normal operation, the access rate affects the access time, and if there is 100 GB of R/W, the access time takes 270 ms per 100 GB, according to the calculation shown in FIG. 12.

In contrast, when a server is infected with the ransomware, a large amount of data is accessed through data theft by ransomware. When a large amount of data is accessed by ransomware to Tier 3, regardless of Tier 1, 2, or 3, as shown in Graph Gr1 and Graph Gr2, the trend is different from the previous trend, the access time becomes longer, and the access speed to data decreases.

For example, as shown in Table TB2, when the server is infected with ransomware, the capacity rate of the data in Tier 1, 2, and 3 affects the access time. Assuming that there is 100 GB R/W, the data access time is 650 ms per 100 GB according to the calculation shown in FIG. 12.

Thus, it can be seen that the access time to data is short (i.e., the access speed to data is fast) in normal operation, while the access speed to data tends to decrease (i.e., the access speed to data decreases) when the server is infected with ransomware.

<Processing Overview>.

The controller 200 of the storage system 100 executes the “abnormal behavior detection process” to detect behavior(s) that may be infected with ransomware as an “abnormal behavior(s)” that are different from normal behavior(s) by using the above detection perspectives (viewpoints) 1 through 3.

The controller 200 performs a “feedback process” to feed back (update) the threshold value and the monitoring interval when calculating the threshold value in order to improve the accuracy of detecting the abnormal behavior.

When the controller 200 detects the abnormal behavior, it performs a “ransomware determination” to determine whether or not the abnormal behavior is detected as unauthorized data access by ransomware in order to improve the accuracy of determination/judgment that the abnormal behavior is caused by ransomware.

If the controller 200 detects the abnormal behavior as unauthorized data access by ransomware by ransomware determination, it executes “unauthorized access response processing,” which is processing for unauthorized access detection.

The following is an overview of the abnormal behavior detection process, the feedback process, a ransomware determination process, and the unauthorized access response process, in turn.

<Abnormal Behavior Detection Process>

The abnormal behavior detection process includes an abnormal behavior detection process 1, an abnormal behavior detection process 2, and an abnormal behavior detection process 3, which are described below. The abnormal behavior detection process 1 may also be referred to as the “first abnormal behavior detection process” for convenience. The abnormal behavior detection process 2 may also be referred to as the “second abnormal behavior detection process” for convenience. The abnormal behavior detection process 3 may also be referred to as the “third abnormal behavior detection process” for convenience.

(Abnormal Behavior Detection Process 1)

According to the detection perspective 1, it can be said that infection by ransomware (unauthorized data access by ransomware) may have occurred if the cache hit rate per volume unit has decreased compared to the normal operation. Therefore, the storage system 100 detects that the cache hit rate per volume has decreased compared to the normal operation as the abnormal behavior. To perform this detection, the controller 200 performs the data referencing, calculation, and comparison processes described below with the volume cache hit rate monitoring program 330.

(Data Referencing Process)

The volume cache hit rate monitoring program 330 obtains the sampling interval from the initial parameter table 230. The volume cache hit rate monitoring program 330 obtains the cache hit rate at each time from the cache hit rate accumulation table 240. The volume cache hit rate monitoring program 330 obtains the threshold cache hit rate from the threshold table 290 by a data reference process.

(Computational Processing)

The volume cache hit rate monitoring program 330 calculates the cache hit rate at the sampling interval (current time). That is, it calculates the cache hit rate at the sampling interval (current) based on the cache hit rate at each time during the period from the current time to the time before (past) the sampling interval (within the sampling interval).

The method of calculating the cache hit rate in the sampling interval (current) is, for example, any of the following (1) through (3).

(1) Using the cache hit rate at each time within the sampling interval, calculate their average value.

(2) The cache hit rate at each time within the sampling interval is integrated over time and the area is calculated.

(3) Within the sampling interval, the slope is calculated using the difference in time and the difference in cache hit rate.

It should be noted that the cache hit rate in the sampling interval (current) may be calculated by other calculation methods. The cache hit rate (i.e., calculated average value, area, or slope, etc.) within the sampling interval may also be referred to as the “first parameter” for convenience. The threshold cache hit rate may also be referred to as the “first threshold parameter” for convenience.

(Comparison Process)

The volume cache hit rate monitoring program 330 compares the cache hit rate (first parameter) in the sampling interval (current) with the threshold cache hit rate. The threshold cache hit rate is, for example, a default value or the like or a value based on past data (e.g., the minimum value of the cache hit rate (first parameter) in the sampling interval for a certain period of past data). When the cache hit rate is smaller than the threshold cache hit rate, the volume cache hit rate monitoring program 330 detects the cache hit rate being smaller than the threshold cache hit rate as abnormal behavior.

(Abnormal Behavior Detection Process 2)

According to the detection perspective 2, if the cache occupancy rate of the host server HSV infiltrated by ransomware has increased compared to normal operation, it can be said that infection by ransomware (unauthorized data access by ransomware) may have occurred. Therefore, the storage system 100 detects that the cache occupancy rate of the host server HSV infiltrated by the ransomware has increased compared to normal operation as abnormal behavior.

To perform this detection, the controller 200 performs the data referencing, calculation, and comparison processes described below with the server cache occupancy rate monitoring program 340.

(Data Referencing Process)

The server cache occupancy monitoring program 340 obtains the sampling interval from the initial parameter table 230. The server cache occupancy monitoring program 340 obtains the cache occupancy rate of the volume at each time from the cache occupancy rate accumulation table 250. The server cache occupancy monitoring program 340 obtains the correspondence between the volume and the host server HSV from the volume-server relationship table 300. The server cache occupancy rate monitoring program 340 obtains the threshold server cache occupancy rate (the sum of the threshold cache occupancy rates associated with the volumes (LdevId) assigned to the host server HSV) from the threshold table 290.

(Computational Processing)

The server cache occupancy rate monitoring program 340 calculates the cache occupancy rate of the volume at the sampling interval (the current time). That is, it calculates the cache occupancy rate of the volume at the sampling interval (current time) based on the cache occupancy rate of the volume at each time during the period from the current time to the time before (past) the sampling interval (within the sampling interval).

The method of calculating the cache occupancy rate of a volume in the sampling interval (current) is, for example, any of the following (1) through (3).

(1) Using the cache occupancy rates of the volumes at each time within the sampling interval, calculate their average value.

(2) Integrate the cache occupancy rate of the volume at each time within the sampling interval over time and calculate the area.

(3) Within the sampling interval, the slope is calculated using the difference in time and the difference in the cache occupancy rate of the volume.

The cache occupancy rate of the host server HSV (server cache occupancy rate) is calculated using the correspondence between the volume and the host server HSV.

It should be noted that other calculation methods may be used to calculate the cache occupancy rate of the volume. The cache occupancy rate (i.e., calculated average value, area, or slope, etc.) of the volume within the sampling interval may also be referred to as the “parameter for calculating the second parameter” for convenience. The server cache occupancy rate (i.e., calculated average value, area, or slope, etc.) within a sampling interval may also be referred to as the “second parameter” for convenience. The threshold server cache occupancy rate may also be referred to as the “second threshold parameter” for convenience.

(Comparison Process)

The server cache occupancy rate monitoring program 340 compares the server cache occupancy rate (second parameter) in the sampling interval (current) with the threshold server cache occupancy rate. The threshold server cache occupancy rate is, for example, “the default setting value” or “the maximum value of the server cache occupancy rate (second parameter) during the sampling interval for a certain period of time in past data”. When the server cache occupancy rate is greater than the threshold server cache occupancy rate, the server cache occupancy rate greater than the threshold server cache occupancy rate is detected as abnormal behavior by the server cache occupancy rate monitoring program 340.

(Abnormal Behavior Detection Process 3)

According to the detection perspective 3, when the data access speed (access speed to data) is reduced compared to normal operation, it can be said that infection by ransomware (unauthorized data access by ransomware) may have occurred. Therefore, the storage system 100 detects that the data access speed has decreased compared to normal operation as abnormal behavior caused by ransomware.

To perform this detection, the controller 200 performs a data referencing process, a calculation process and a comparison process with the data access speed monitoring program 350.

(Data Referencing Process)

The data access speed monitoring program 350 obtains the sampling interval from the initial parameter table 230. The data access speed monitoring program 350 obtains the data access speed at each time from the data access speed accumulation table 260. The data access speed monitoring program 350 obtains the threshold data access speed from the threshold table 290.

(Calculation Process)

The data access speed monitoring program 350 calculates the data access speed at the sampling interval (current time). That is, the data access speed monitoring program 350 calculates the data access speed at the sampling interval (current) based on the data access speed at each time during the period from the current time to the time before (past) the sampling interval (within the sampling interval).

The method of calculating the data access speed is, for example, any of the following (1) through (3).

(1) Using the data access speeds at each time within the sampling interval, calculate their average value.

(2) Integrate the data access speed at each time within the sampling interval with time and calculate the area.

(3) Within the sampling interval, the slope is calculated using the difference in time and the difference in data access speed.

It should be noted that the data access speed at the sampling interval (current) may be calculated by other calculation methods. The data access speed (i.e., calculated average value, area, or slope, etc.) at the sampling interval (current) may also be referred to as the “third parameter” for convenience. The threshold data access speed may also be referred to as the “third threshold parameter” for convenience.

(Comparison Process)

The data access speed monitoring program 350 compares the data access speed (third parameter) in the sampling interval (current) with the threshold data access speed. The threshold data access speed is, for example, “the default setting value” or “the minimum value of the data access speed (third parameter) in the sampling interval for a certain period of time of past data”. If the data access speed is less than the threshold data access speed, the data access speed monitoring program 350 detects the data access speed being less than the threshold data access speed as abnormal behavior.

<Feedback Processing>

The feedback process is described below. The feedback process includes threshold feedback by the threshold feedback program 360 and monitoring interval feedback by the monitoring interval feedback program 370.

(Threshold Feedback)

The controller 200 provides feedback on the threshold values by means of the threshold feedback program 360.

The thresholds shall be provisional values based on measurements obtained from operational tests or values designed by the system designer or software designer. When the system goes into production, the minimum value of the cache hit rate (the first parameter), the maximum value of the cache occupancy rate (the “parameter for calculating the second parameter”) of the volume for calculating the server cache occupancy rate (the second parameter), and the minimum value of the data access speed (the third parameter) are calculated from the stored data. The threshold values (the threshold cache hit rate, the threshold server cache occupancy rate, and the threshold data access rate) are dynamically modified by the results. These maximum or minimum values are calculated based on the values measured at each predetermined monitoring interval. This monitoring interval is dynamically modified by the monitoring interval feedback.

The threshold feedback program 360 recalculates and dynamically updates the threshold value depending on the operating status of the system, thereby improving the detection accuracy of abnormal behavior (unauthorized access by ransomware). The threshold feedback program 360 may be invoked once a day, once a week, once a month, etc. The threshold feedback program 360 may be manually executed by the user at the required timing.

(Monitoring Interval Feedback)

The controller 200 provides feedback on the monitoring interval by means of monitoring interval feedback program 370.

There is a wide variety of system operations, some systems remain virtually unchanged, while others change periodically or irregularly. In the same system, the method of operation may change from time to time. Therefore, the controller 200 feeds back the monitoring interval to correspond to the operational patterns of the system.

For example, if the operational pattern of the system is “roughly constant”, then one day or a predetermined number of days is set as the monitoring interval. The threshold value is then calculated by comparing the values calculated for that monitoring interval by the threshold feedback described above.

If the operational pattern of the system tends to be the same from year to year, the monitoring interval is set at one year, as in last year, the year before, and so on. The threshold value is then calculated by comparing the values calculated at that monitoring interval by the threshold feedback described above.

If the operational pattern of the system is “same trend for each days of the week,” then the monitoring interval is set so that it compares to the same day of the week each week. The threshold value is then calculated by comparing the values calculated at that monitoring interval by the threshold feedback described above.

If the operational pattern of the system is “trending by date,” then the monitoring interval is set to compare with that date in the last month, the month before last, and so on. The threshold value is then calculated by the threshold feedback described above by comparing the values calculated for that monitoring interval.

Thus, if the system has a trend (behavior) of data that occurs periodically after the storage system 100 goes into production, the monitoring interval feedback program 370 calculates the period of the trend according to the operational status of the system and dynamically modifies the monitoring interval according to the period of the trend. This can improve the detection accuracy of abnormal behavior.

<Ransomware determination>.

If “abnormal behavior” is detected at the storage layer, it is possible that the ransomware is stealing data. On the other hand, temporary special events (e.g., configuration changes/addition of new APPs) during normal operations may also cause unusual trends. In other words, data trends (data change trends) similar to abnormal behavior may occur.

The detection of this abnormal behavior may be used to detect unauthorized access by ransomware (see Variation 1 below). On the other hand, however, the abnormal behavior in such cases may be indistinguishable from the ransomware, which may reduce the detection accuracy. For example, if the abnormal behavior is out of the normal range (e.g., the cache hit rate of one volume has dropped), which is determined simply by past values, the detection accuracy may be degraded.

Therefore, when the controller 200 detects abnormal behavior, it determines whether or not the abnormal behavior is caused by ransomware by the ransomware determination program. This allows the controller 200 to increase the accuracy of ransomware detection.

Here, the ransomware has the following behaviors (1) through (4).

Behavior (1) When data is stolen by ransomware, a large amount of data accesses are generated or data transfers are rapidly increased.

Behavior (2) Ransomware attacks all terminals and servers in a network at once when stealing data.

Behavior (3) Data destruction after data theft.

Behavior (4) Ransomware tries to take data as quickly as possible during data theft.

Focusing on such ransomware behavior, ransomware determination is performed by the ransomware determination program (cache hit rate perspective) 380 and the ransomware determination program (data access speed perspective) 390, as described below.

(Ransomware Determination Check (Cache Hit Rate Perspective))

When the abnormal behavior has been detected, the ransomware determination program (cache hit rate perspective) 380 can determine whether the abnormal behavior is caused by ransomware by performing at least one of the following determinations A through D.

(Determination A)

According to behavior (1), since ransomware accesses a lot, it is possible to determine whether the abnormal behavior is caused by ransomware by examining whether other volumes on the same host server HSV also show the same tendency.

Therefore, the ransomware determination program (cache hit rate perspective) 380 determines whether other volumes in the host server HSV to which the corresponding volume to which the abnormal behavior was detected is assigned also show a similar cache hit rate trend (i.e., whether the cache hit rate at the sampling interval (current) (i.e., whether or not the cache hit rate at the sampling interval (current) is less than the threshold cache hit rate).

If other volumes in the host server HSV also show the similar cache hit rate trend, the abnormal behavior is determined to be caused by ransomware. That is, the ransomware determination program (cache hit rate perspective) 380 detects the abnormal behavior as unauthorized access caused by ransomware.

(Determination B)

According to behavior (1), since ransomware accesses a lot, it is possible to determine whether the abnormal behavior is caused by ransomware by examining whether other volumes on other host server HSV(s) exhibit similar trends.

Therefore, the ransomware determination program (cache hit rate perspective) 380 determines whether or not a similar cache hit rate trend appears in the volumes of other host server HSV(s) other than the host server HSV to which the corresponding volume is assigned.

If similar cache hit rate trends appear in the volumes of other host server HSV(s), the abnormal behavior is determined to be caused by ransomware. That is, the ransomware determination program (cache hit rate perspective) 380 detects the abnormal behavior as unauthorized access caused by ransomware.

(Determination C)

According to behavior (3), since the ransomware destroys data after data exploitation, the cache hit rate should not return to normal. Therefore, it is possible to determine whether the abnormal behavior is caused by ransomware by checking whether the cache hit rate has returned to its usual trend.

Therefore, the ransomware determination program (cache hit rate perspective) 380 determines whether or not there are any volumes whose cache hit rate has returned to its usual trend. If there is no volume whose cache hit rate has returned to the usual trend, the ransomware determination program (cache hit rate perspective) 380 determines that the abnormal behavior is caused by ransomware. That is, the ransomware determination program (cache hit rate perspective) 380 detects the abnormal behavior as unauthorized access caused by ransomware.

(Determination D)

Since a decrease in the cache hit rate is also caused by a virus scan, it is desirable from the viewpoint of reducing false positives to determine whether the decrease in the cache hit rate is caused by a virus scan or not. Here, regarding IOPS, according to behavior (4), IOPS is larger than usual for the ransomware because the ransomware is extracting data as quickly as possible, while IOPS is smaller for virus scan because virus scan is reading data while checking data. With this in mind, the ransomware determination program (cache hit rate perspective) 380 judges/determines whether the IOPS of the volume (the volume in question and other volumes showing a similar cache hit rate trend) is larger than usual. If the volume's IOPS is larger than usual, the ransomware determination program (cache hit rate perspective) 380 determines that the abnormal behavior is caused by ransomware. That is, the ransomware determination program (cache hit rate perspective) 380 detects the abnormal behavior as unauthorized access caused by ransomware.

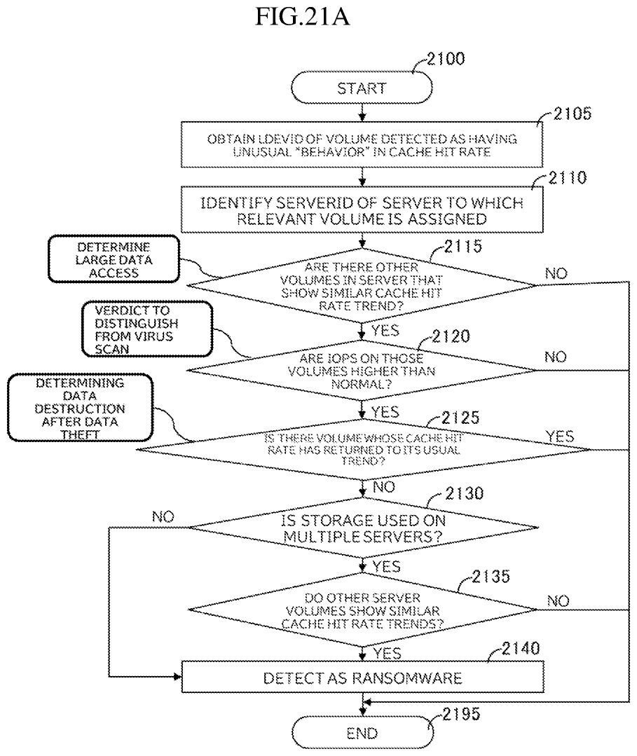

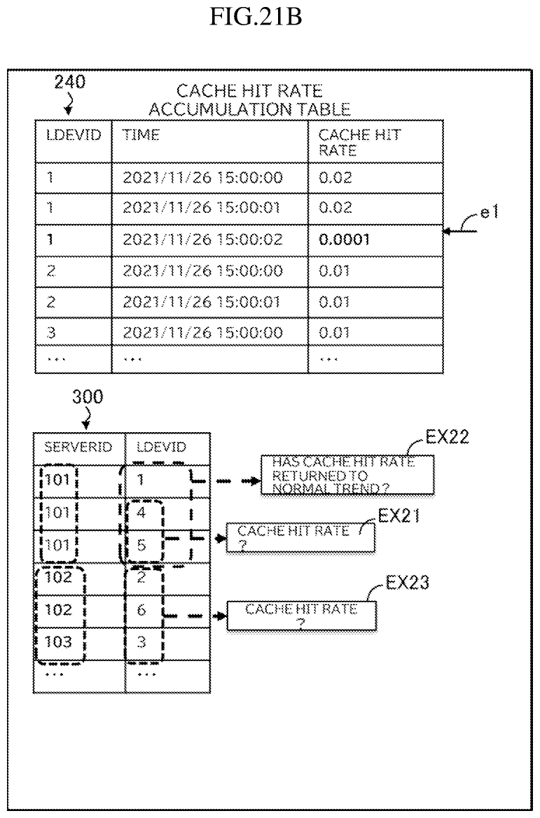

The ransomware determination program (cache hit rate perspective) 380 may execute at least one of the above determinations A through D and determine that the abnormal behavior is caused by ransomware when the result of at least one determination is “YES”. In this example, the storage system is used by multiple host servers HSV, and in the processing flow shown in the flowchart in FIG. 21A below, the abnormal behavior is determined to be caused by ransomware when the results of all the above determinations A through D are “YES”. The process flow shown in FIG. 21A flowchart below determines that the abnormal behavior is caused by ransomware.

(Ransomware Determination Check (Data Access Speed Perspective))

According to behavior (2), terminals and servers in the network are attacked simultaneously when data is stolen by ransomware. Therefore, it is possible to determine whether the abnormal behavior is caused by ransomware by examining whether similar data access speed trends also appear in the volumes of other host server HSV(s) other than the host server HSV to which the volume in question is assigned.

Therefore, the ransomware determination program (data access speed perspective) 390 determines whether the volumes of other host server HSV(s) other than the host server HSV to which the corresponding volume to which the abnormal behavior is detected is assigned also have a reduced data access speed (i.e. determine whether the data access speed at the sampling interval (current) is less than the threshold access speed).

When the volume of other host server HSV(s) also has a reduced data access speed, the abnormal behavior is determined to be caused by ransomware. That is, the ransomware determination program (data access speed perspective) 390 detects the abnormal behavior as unauthorized access caused by ransomware.

<Unauthorized Access Response Processes>

When the controller 200 detects unauthorized access by ransomware, it executes the unauthorized access response process.

Examples of the unauthorized access response processes include the processes described below.

The controller 200 identifies the target server that was illegally accessed and cuts the PATH.

The controller 200 notifies the administrator's terminal that unauthorized access has occurred.

In addition to the above notification, the controller 200 reduces the amount of data transferred. If this is done while waiting for the controller to respond, it will counteract the data leakage.

In addition to the above notification, the controller 200 will also slow down the transfer rate of data in storage. If this is done while waiting for the administrator's response, it is a countermeasure against data leakage.

If the system is a system to which a technology such as CDP is applied, the controller 200 returns data at a timing and combination that is determined to have been normal. Continuous Data Protection (CDP) is a function that returns data that has been tampered with due to the ransomware or other causes to the data state at any given point in time by continuously leaving past data in the pool on a write-by-write basis.

The controller 200 automatically runs virus scans.

<Specific Operation>

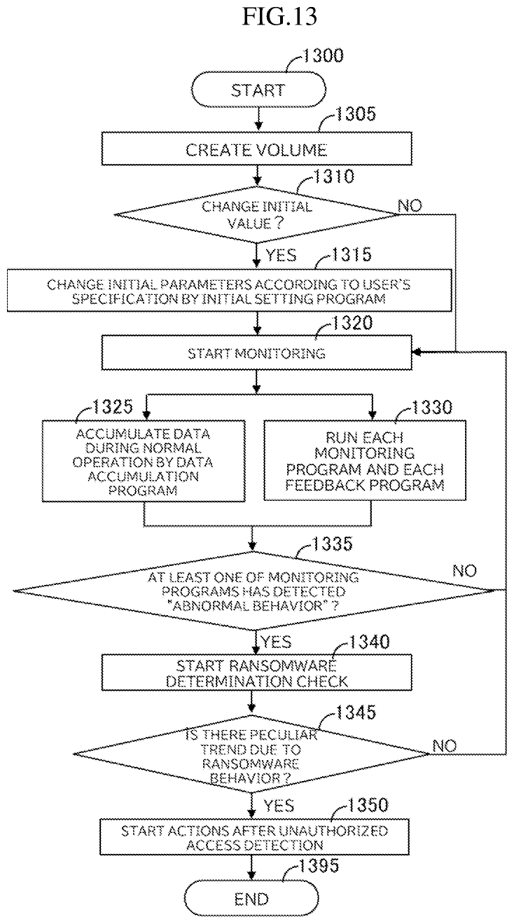

The specific operation of the storage system 100 is described below. FIG. 13 is a flowchart showing the processing flow to explain the overall processing flow executed by the controller 200 of the storage system 100. The controller 200 executes the processing flow shown in FIG. 13. Accordingly, the controller 200 starts processing from step 1300 in FIG. 13 and proceeds to step 1305 to create a volume (the DP volume 420). The volume is created, for example, in response to an instruction from the administrator terminal (not shown).

The controller 200 then proceeds to step 1310 to determine whether to change the initial value.

When the initial value is changed, the controller 200 makes a “YES” determination at step 1310 and proceeds to step 1315 to change the initial parameters according to the user's specification by the initial setting program (the initial setting change program 310). The user can specify the initial parameters, for example, by operating the administrator (not shown). The details of the processing of step 1315 are described below.

In contrast, when the initial value is not changed, the controller 200 makes a “NO” determination at step 1310 and proceeds directly to step 1320.

When the controller 200 proceeds to step 1320, it starts monitoring the storage system 100 and initiates the parallel execution of the processes in steps 1325 and 1330 described below, and then proceeds to step 1335.

Step 1325: The controller 200 accumulates data during normal operation by means of the data accumulation program 320. The details of the processing of step 1325 are described below.

Step 1330: The controller 200 runs each monitoring program and each feedback program. The monitoring programs are the volume cache hit rate monitoring program 330, the server cache occupancy rate monitoring program 340, and the data access speed monitoring program 350. The feedback programs are the threshold feedback program 360 and the threshold interval feedback program 370. Details of the processing of step 1330 are described below.

The controller 200 proceeds to step 1335 to determine whether at least one of the monitoring programs has detected the “abnormal behavior,” which is the unusual behavior described above.

When the “abnormal behavior” is detected, the controller 200 makes a “YES” determination at step 1335 and proceeds to step 1340 to start a ransomware determination check by the ransomware determination. The details of the processing of step 1340 are described below.

The controller 200 then proceeds to step 1345 to determine whether there is a peculiar trend due to ransomware behavior. That is, the controller 200 determines whether the abnormal behavior is due to ransomware by the ransomware determination.

When there is no peculiar trend due to ransomware behavior, the controller 200 makes a “NO” determination at step 1345 and returns to step 1320 to continue monitoring.

In contrast, when there is a peculiar trend due to ransomware behavior, the controller 200 makes a “YES” determination at step 1345 and proceeds to step 1350 to start actions after unauthorized access detection (i.e., starts executing the unauthorized access response process described above). The controller 200 then proceeds to step 1395 to temporarily terminate this processing flow.

<Step 1315>

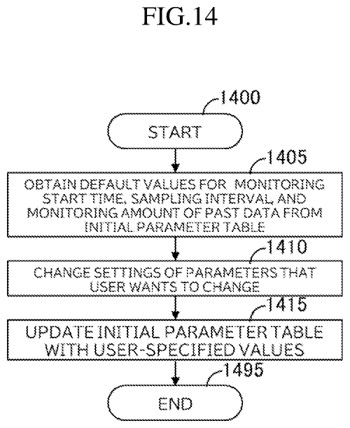

The details of the processing of step 1315 described above are described below. FIG. 14 is a flowchart showing the processing flow executed by the initial setting change program 310. The initial setting change program 310 starts the processing from step 1400 and executes steps 1405 through 1415 described below in order, and then proceeds to step 1495 to temporarily terminate this processing flow.

Step 1405: The initial setting change program 310 obtains default values for the monitoring start time, sampling interval, and a monitoring amount of past data from the initial parameter table 230.

Step 1410: The initial setting change program 310 changes the settings of the parameters that the user wants to change.

Step 1415: The initial setting change program 310 updates the initial parameter table 230 with user-specified values.

<Step 1325>

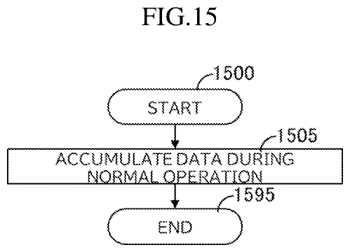

The details of the processing of step 1325 described above are described below. FIG. 15 is a flowchart showing the processing flow executed by the data accumulation program 320. The data accumulation program 320 starts processing from step 1500, executes the processing of step 1505 described below, and then proceeds to step 1595 to temporarily terminate this processing flow.

Step 1505: The data accumulation program 320 accumulates data (time series data) during normal operation of the storage system 100. The data is sequentially acquired and stored in the cache hit rate accumulation table 240, the cache occupancy rate accumulation table 250, the data access speed accumulation table 260, and the IOPS accumulation table 270, etc.

<Step 1330>

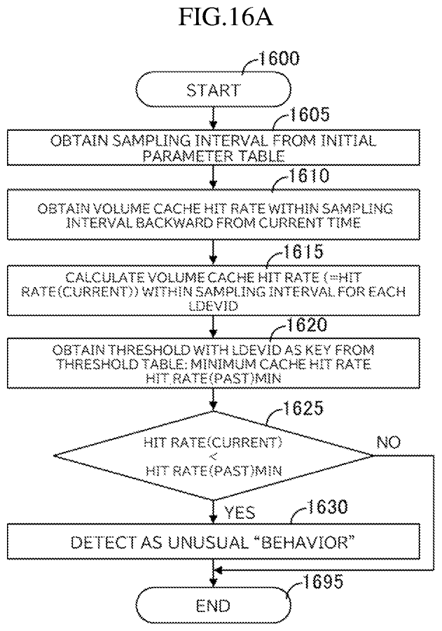

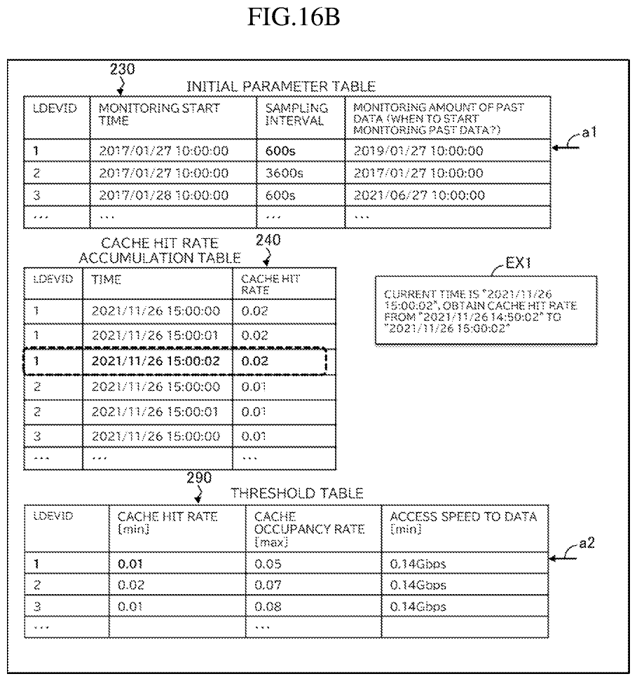

The details of the processing of step 1330 described above are explained using FIG. 16A through FIG. 20B. FIG. 16A is a flowchart showing the processing flow executed by the volume cache hit rate monitoring program 330. FIG. 16B illustrates a specific example to facilitate understanding of the processing flow in FIG. 16A.

The volume cache hit rate monitoring program 330 starts processing from step 1600 and performs steps 1605 through 1620 described below in order, and then proceeds to step 1625.

Step 1605: The volume cache hit rate monitoring program 330 obtains the sampling interval from the initial parameter table 230 (initial setting table). As shown in FIG. 16B, for example, for LdevId 1, the volume cache hit rate monitoring program 330 obtains the sampling interval 600s for the record indicated by arrow a1 from the initial parameter table 230. The same process is performed for each of the other LdevId, but the explanation is omitted (the same hereinafter).

Step 1610: The volume cache hit rate monitoring program 330 obtains the volume cache hit rate (cache hit rate per volume) within the sampling interval backward from the current time. As shown in the description EX1 in FIG. 16B the volume cache hit rate monitoring program 330 obtains, for example, the cache hit rate for each time within the sampling interval from “2021/11/26 14:50:02” to “2021/11/26 15:00:02” from the cache hit rate accumulation table 240 for LdevId 1.

Step 1615: The volume cache hit rate monitoring program 330 calculates the volume cache hit rate (=Hit Rate(current)) within the sampling interval for each LdevId. The volume cache hit rate (=Hit Rate(current)) within the sampling interval here is, for example, the average value (i.e., the first parameter) of the cache hit rate per volume at each time within the sampling interval.

Step 1620: The volume cache hit rate monitoring program 330 obtains a threshold cache hit rate (=minimum value (=Hit Rate(past)min) of the cache hit rate (first parameter)) with LdevId as a key from the threshold table 290. As shown in FIG. 16B, the volume cache hit rate monitoring program 330 obtains, for example, the threshold cache hit rate (=0.01) for the record indicated by arrow a2 from the threshold table 290 for LdevId 1.

The volume cache hit rate monitoring program 330 proceeds to step 1625 to determine whether the volume cache hit rate (=Hit Rate(current)) within the sampling interval is less than the threshold cache hit rate (=the minimum value (=Hit Rate(past)min) of the cache hit rate (the first parameter). This process is also performed for each LdevId.

When the volume cache hit rate (=Hit Rate(current)) within the sampling interval is smaller than the threshold cache hit rate (=Hit Rate(past)min), the volume cache hit rate monitoring program 330 makes a “YES” determination at step 1625 and proceeds to step 1630 to detect that the volume cache hit rate within the sampling interval is smaller than the threshold cache hit rate as an unusual behavior (abnormal behavior). This determination is performed for each LdevId.

The volume cache hit rate monitoring program 330 then proceeds to step 1695 to temporarily terminate this processing flow.

In contrast, when the volume cache hit rate (=Hit Rate(current)) within the sampling interval is greater than or equal to the threshold cache hit rate (=Hit Rate(past)min), the volume cache hit rate management program makes a “NO” determination at step 1625 and proceeds to step 1695 to temporarily terminate this processing flow.

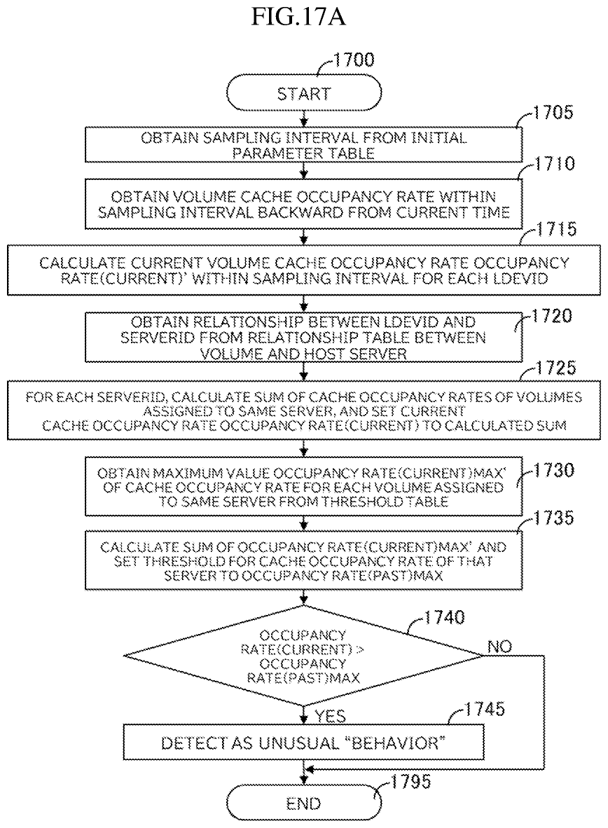

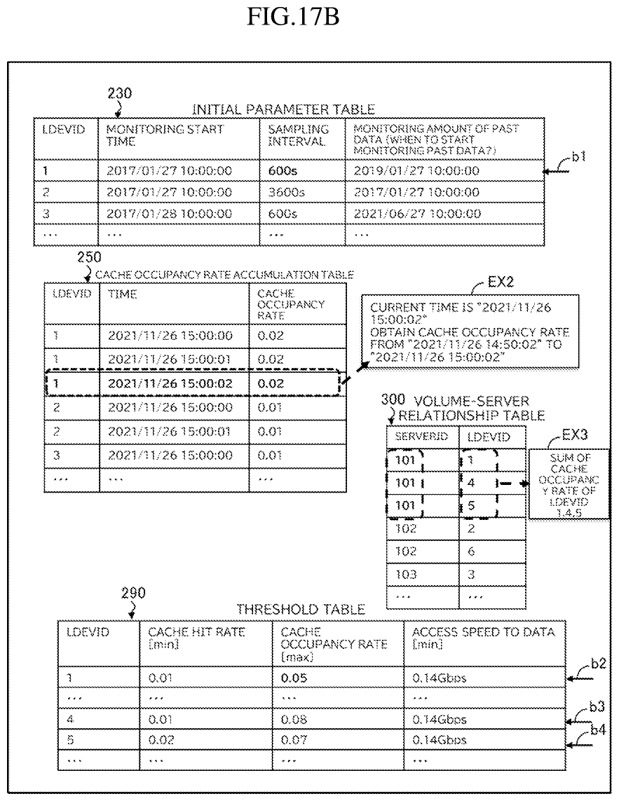

FIG. 17A is a flowchart showing the processing flow executed by the server cache occupancy rate monitoring program 340; FIG. 17B is a diagram illustrating a specific example to facilitate understanding of the processing flow in FIG. 17A.

The server cache occupancy rate monitoring program 340 starts processing from step 1700 and performs steps 1705 through 1735 described below in order, and then proceeds to step 1740.

Step 1705: The server cache occupancy rate monitoring program 340 obtains the sampling interval from the initial parameter table 230 (initial configuration table). As shown in FIG. 17B, for example, for LdevId 1, the server cache occupancy rate monitoring program 340 obtains the initial sampling interval of 600s for the record indicated by arrow b1 from the initial parameter table 230. The same process is performed for each of the other LdevId, but the explanation is omitted (same hereinafter).

Step 1710: The server cache occupancy rate monitoring program 340 obtains the volume cache occupancy rate within the sampling interval backward from the current time. As shown in the description EX2 in FIG. 17B, for LdevId 1 obtain the volume unit cache occupancy rate for each time within the sampling interval from “14:50:02 on 11/26/2021” to “15:00:02 on 11/26/2021” from the cache occupancy rate accumulation table 250.

Step 1715: The server cache occupancy rate monitoring program 340 calculates the volume cache occupancy rate (=Occupancy Rate(current)′) within the current sampling interval for each LdevId. The volume cache occupancy rate within the sampling interval (=Occupancy Rate(current)′) here is the average value of the cache occupancy rate at each time during the sampling interval (i.e., the parameter for calculating the second parameter).

Step 1720: The server cache occupancy rate monitoring program 340 obtains the relationship between LdevId and ServerId from the relationship table between the volume and the host server HSV (the volume-server relationship table 300).

Step 1725: The server cache occupancy rate monitoring program 340 calculates, for each ServerId, the sum of the cache occupancy rates (the parameter for calculating the second parameter) of the volumes within the sampling interval allocated to the same server, as the current server cache rate (=Occupancy Rate(current)) of that host server HSV. As shown in EX3 in FIG. 17B, the server cache occupancy rate monitoring program 340 calculates, for example, for ServerId 101, the sum of the cache occupancy rates (the parameter for calculating the second parameter) of Ldev1, 4, and 5 within the sampling intervals. The same process is performed for other ServerId, but the explanation is omitted (the same applies hereinafter).

Step 1730: The server cache occupancy rate monitoring program 340 obtains from the threshold table 290 the threshold cache occupancy rate for each volume allocated to the same server (i.e., the maximum cache occupancy rate (=Occupancy Rate(current)max′)) for each volume allocated to the same server from the threshold table 290.

Step 1735: The server cache occupancy rate monitoring program 340 calculates the sum of the threshold cache occupancy rate (=Occupancy Rate(current)max′) and the threshold server cache occupancy rate (=Occupancy Rate(past)max) of the server cache occupancy rate for that the host server HSV. As shown in FIG. 17B, the server cache occupancy rate monitoring program 340 calculates, for example, the sum of the cache occupancy rates for each record indicated by arrows b2, b3 and b4 in the threshold table 290.

The server cache occupancy rate monitoring program 340 proceeds to step 1740 to determine whether the server cache occupancy rate (=Occupancy Rate(current)) within the sampling interval is greater than the threshold server cache occupancy rate (=Occupancy Rate(past)max).

When the server cache occupancy rate (=Occupancy Rate(current)) within the sampling interval is greater than the threshold server cache occupancy rate (=Occupancy Rate(past)max), the server cache occupancy rate monitoring program 340 makes a “YES” determination at step 1740 and proceeds to step 1745 to detect the server cache occupancy rate (=Occupancy Rate(current)) being greater than the threshold server cache occupancy rate (=Occupancy Rate(past)max) as an unusual behavior (abnormal behavior). It should be noted that this determination is performed for each ServerId. The server cache occupancy rate monitoring program 340 then proceeds to step 1795 to temporarily terminate this processing flow.

In contrast, when the server cache occupancy rate (=Occupancy Rate(current)) within the sampling interval is less than or equal to the threshold server cache occupancy rate (=Occupancy Rate(past)max), the server cache occupancy rate monitoring program 340 makes a “NO” determination at step 1740 and proceeds to step 1795 to terminate this processing flow.

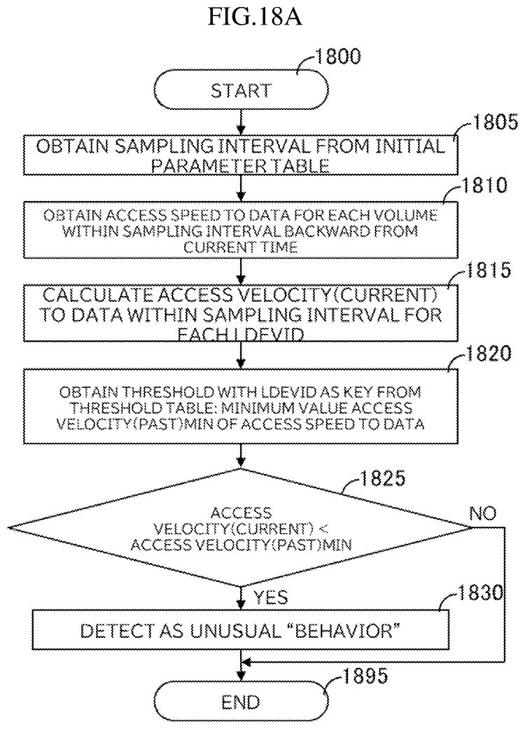

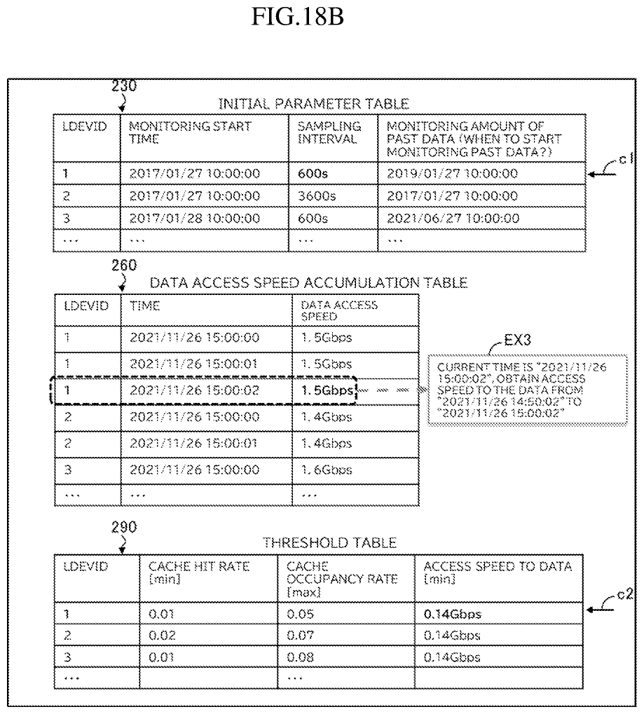

FIG. 18A is a flowchart showing the processing flow executed by the data access speed monitoring program 350; FIG. 18B is a diagram illustrating a specific example to facilitate understanding of the processing flow in FIG. 18A.

The data access speed monitoring program 350 starts processing from step 1800 and executes the processes of steps 1805 through 1820 described below in sequence, then proceeds to step 1825.

Step 1805: The data access speed monitoring program 350 obtains the sampling interval from the initial parameter table 230 (initial configuration table). As shown in FIG. 18B, for example, for LdevId 1, the data access speed monitoring program 350 obtains, from the initial parameter table 230 to obtain the sampling interval of 600s for the record indicated by the arrow c1. The same process is performed for each of the other LdevId, but the explanation is omitted (same hereinafter).

Step 1810: The data access speed monitoring program 350 obtains the access speed to data for each volume within the sampling interval backward from the current time. As shown in the description EX3 in FIG. 18B, the volume cache hit rate monitoring program 330, for example, for LdevId 1, retrieve the data access speed for each time within the sampling interval from “2021/11/26 14:50:02” to “2021/11/26 15:00:02” from the data access speed accumulation table 260.

Step 1815: The data access speed monitoring program 350 calculates the access velocity to the data within the sampling interval (=Access Velocity(current)) for each LdevId. The access velocity to data within the sampling interval (data access velocity) here is, for example, the average value of the data access velocity at each time within the sampling interval (i.e., the third parameter).

Step 1820: The data access speed monitoring program 350 obtains a threshold data access speed (=minimum value of data access speed (third parameter) (=Access Velocity(past)min)) from the threshold table 290 with LdevId as a key. As shown in FIG. 18B, the data access speed monitoring program 350 obtains, for example, the threshold data access speed (=0.14 Gbps) for the record indicated by arrow c2 from the threshold table 290 for LdevId 1.

The data access speed monitoring program 350 proceeds to step 1825 to determine whether the access velocity to data within the sampling interval (=Access Velocity(current)) is less than the threshold data access velocity (=Access Velocity(past)min). Determination.

When the access velocity to the data within the sampling interval (=Access Velocity(current)) is less than the threshold data access velocity (=Access Velocity(past)min), the data access speed monitoring program 350 makes a “YES” determination at step 1825 and proceeds to step 1830 to detect, as an unusual behavior (abnormal behavior), that the access speed/velocity to the data within the sampling interval (=Access Velocity(current)) is less than the threshold data access speed/velocity (=Access Velocity(past)min).

This determination is performed for each LdevId. The data access speed monitoring program 350 then proceeds to step 1895 to temporarily terminate this processing flow.

In contrast, when the access velocity to data within the sampling interval (=Access Velocity(current)) is greater than or equal to the threshold data access velocity (=Access Velocity(past)min), the data access speed monitoring program 350 makes a “NO” determination at step 1825 and proceeds to step 1895 to temporarily terminate this processing flow.

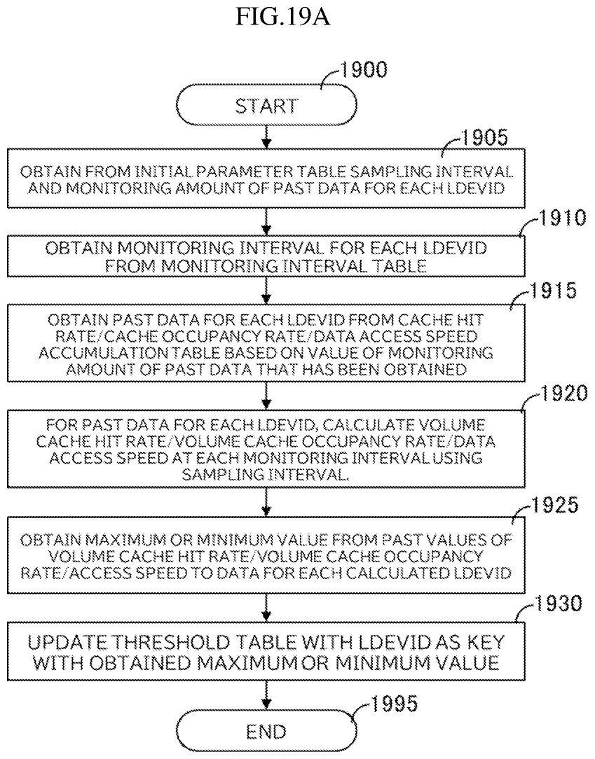

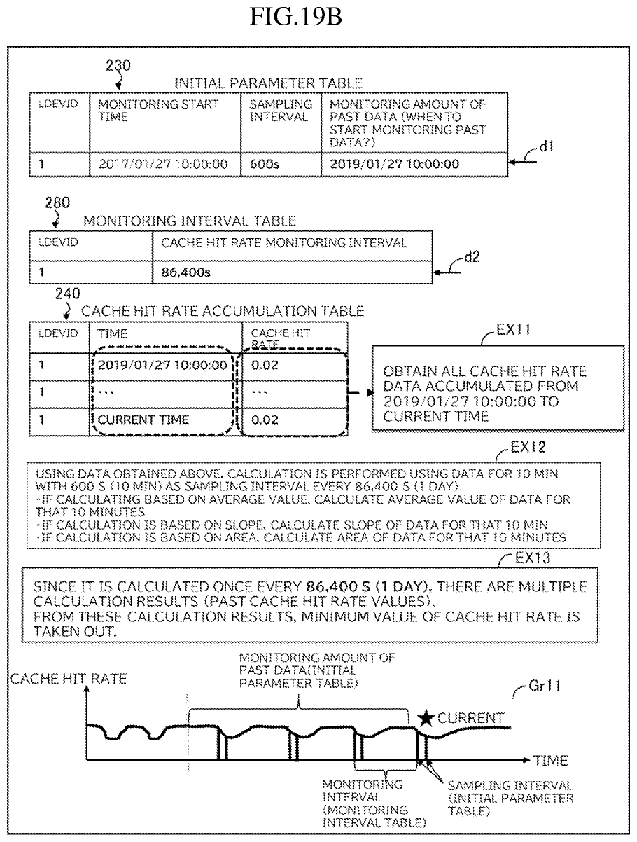

FIG. 19A is a flowchart showing the processing flow executed by the threshold feedback program 360. FIG. 19B is a diagram illustrating a specific example to facilitate understanding of the processing flow in FIG. 19A.

The threshold feedback program 360 starts processing from step 1900 and executes steps 1905 through 1930, which are described below, in sequence. Thereafter, the threshold feedback program 360 proceeds to step 1995 to temporarily terminate this processing flow.

Step 1905: The threshold feedback program 360 obtains from the initial parameter table 230 the sampling interval and the monitoring amount of past data for each LdevId. As shown in FIG. 19B, for example, for LdevId 1, the threshold feedback program 360 obtains the initial sampling interval 600s and the monitoring amount of past data (10:00:00 on 01/27/2019) for the record indicated by the arrow d1 from the initial parameter table 230. The same process is performed for each of the other LdevId, but the explanation is omitted (same hereinafter).

Step 1910: The threshold feedback program 360 obtains the monitoring interval for each LdevId from the monitoring interval table 280. As shown in FIG. 19B, for example, for LdevId 1, the threshold feedback program 360 obtains, from the monitoring interval table 280, the cache hit rate monitoring interval (86400s) for the record, the record being indicated by the arrow d2

Step 1915: The threshold feedback program 360 retrieves past data for each LdevId from the cache hit rate accumulation table 240, the cache occupancy rate accumulation table 250 and the data access speed accumulation table 260 based on the value of the monitoring amount of past data. As shown in illustrated by EX11 in FIG. 19B, the threshold feedback program 360, for example, retrieves/obtains, for LdevId 1, all the data of the cache hit rate at each time accumulated from “1/27/2019 10:00:00” to the current time from the cache hit rate accumulation table 240.

Step 1920: In the historical data for each LdevId, the threshold feedback program 360 calculates, for each monitoring interval, the cache hit rate of the volume, the cache occupancy rate of the volume and the access speed to the data within the sampling interval using the sampling interval. As shown in the description EX12 in FIG. 19B, the threshold feedback program 360 calculates, for example, in the above acquired data, every 86,400s (1 day) interval, using 600s (10 min) as the sampling interval and the data between those 10 min. In this example, for example, the average value of the data during the 10 min period (i.e., the first parameter, the second parameter calculation parameter, and the third parameter) is calculated.

Step 1925: The threshold feedback program 360 calculates the minimum value of the cache hit rate of the volume (i.e., the first parameter) within the sampling interval, the maximum value of the cache occupancy rate (i.e., the parameter for calculating the second parameter) of the volume within the sampling interval, and the minimum value of the access speed to data (i.e., the third parameter) within the sampling interval, based on the cache hit rate (the first parameter), the cache occupancy rate (the second parameter), and the data access speed (the third parameter), of the volume within the calculated sampling interval for each LdevId

As shown in the description EX13 and Graph Gr11 in FIG. 19B, the threshold feedback program 360 calculates once every 86, 400s (1 day) interval, so there are multiple calculation results (past values of cache hit ratio). From those calculation results, the minimum value of the cache hit rate (the first parameter) is extracted/obtained. It should be noted that the same is true for the maximum value of the cache hit rate (the parameter for calculating the second parameter) and the minimum value of the data access speed (the third parameter).

Step 1930: The threshold feedback program 360 updates the threshold table 290 by the retrieved minimum value of the cache hit rate (the first parameter), the maximum value of the cache occupancy rate of the volume (the parameter for calculating the second parameter) and the minimum value of the access speed to the data (i.e., the third parameter), using LdevId as the key.

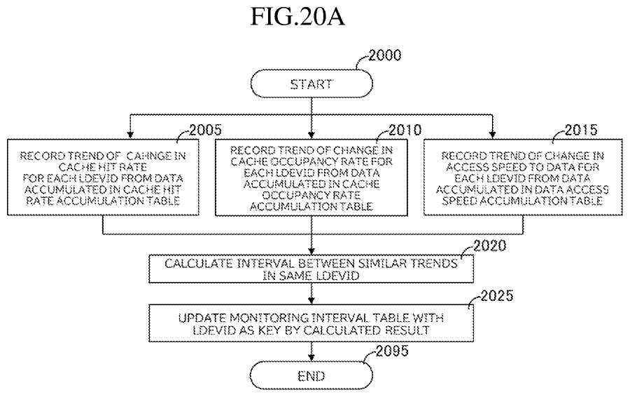

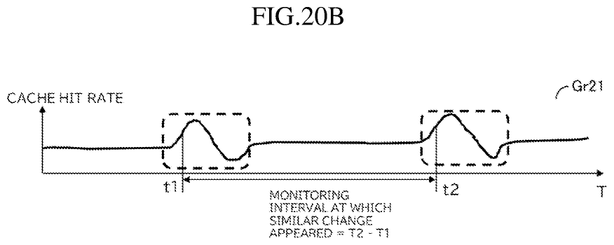

FIG. 20A is a flowchart showing the processing flow executed by the monitoring interval feedback program 370. FIG. 20B is a diagram to facilitate understanding of the processing flow in FIG. 20A.

The monitoring interval feedback program 370 starts processing from step 2000 to initiate the parallel execution of steps 2005 through 2015 described below, and then proceeds to step 2020.

Step 2005: The monitoring interval feedback program 370 records the changing trend of the cache hit rate for each LdevId from the data accumulated in the cache hit rate accumulation table 240.

Step 2010: The monitoring interval feedback program 370 records the trend of change in cache occupancy for each LdevId from the data accumulated in the cache occupancy rate accumulation table 250.

Step 2015: the monitoring interval feedback program 370 records the changing trend of access speed to data for each LdevId from the data stored in the data access speed accumulation table 260.

The monitoring interval feedback program 370 then performs steps 2020 and 2025 described below in sequence, and then proceeds to step 2095 to temporarily terminate this process flow.

Step 2020: The monitoring interval feedback program 370 calculates the interval between similar change trends in the same LdevId. As shown by Graph Gr21 in FIG. 20B, the monitoring interval feedback program 370, for example, calculates the monitoring interval (t2−t1) between the first time point t1 and the second time point t2 at which a similar change in cache hit rate appears. The same is true for the cache occupancy rate and the access speed to data.

Step 2025: The monitoring interval feedback program 370 updates the monitoring interval table 280 with the LdevId as a key, by the calculated results.

<Step 1340>

FIG. 21A is a flowchart showing the processing flow executed by the ransomware determination program (cache hit rate perspective) 380. FIG. 21B illustrates a specific example to facilitate understanding of the processing flow in FIG. 21A. The ransomware determination program (cache hit rate perspective) 380 starts processing from step 2100 and executes steps 2105 and 2110 described below in order, and then proceeds to step 2115.

Step 2105: The ransomware determination program (cache hit rate perspective) 380 obtains the LdevId of the volume for which the abnormal behavior is detected in the cache hit rate. For example, LdevId 1 of the volume for which the abnormal behavior is detected is obtained.

Step 2110: The ransomware determination program (cache hit rate perspective) 380 identifies the ServerId of the host server HSV to which the corresponding volume is assigned by referring to the volume-server relationship table 300. As shown in FIG. 21B for example, the ransomware determination program (cache hit rate perspective) 380 identifies ServerId 101 to which the volume of LdevId 1 is allocated by referring to the volume-server relationship table 300.

The ransomware determination program (cache hit rate perspective) 380 proceeds to step 2115 to determine whether there are other volumes in the corresponding the host server HSV that show similar cache hit rate trends. This allows determining whether there is a high possibility that a large amount of data is being accessed by the ransomware. It should be noted that the determination in step 2115 may also be referred to as the “first determination” for convenience. As shown in the description EX21 in FIG. 21B, the ransomware determination program (cache hit rate perspective) 380 refers to the volume-server relationship table 300 to identify other LdevId 4 and LdevId 5 assigned to ServerId 101. The ransomware determination program (cache hit rate perspective) 380 refers to the cache hit rate accumulation table 240 to determine whether a cache hit rate trend (the abnormal behavior) similar to the trend of the cache hit rate of the volume of LdevId 1 appears in the other LdevId 4 and LdevId 5.

When there are no other volumes in the relevant server that show a similar cache hit rate trend, it is unlikely that a large amount of data is being accessed by ransomware. Therefore, in this case, the ransomware determination program (cache hit rate perspective) 380 makes a “NO” determination at step 2115, proceeds to step 2195, and temporarily terminates this processing flow.

In contrast, when there are other volumes in the relevant server that show a similar cache hit rate trend, there is a high possibility that a large amount of data is being accessed by ransomware. Therefore, in this case, the ransomware determination program (cache hit rate perspective) 380 makes a “YES” determination at step 2115 and proceeds to step 2120.

The ransomware determination program (cache hit rate perspective) 380 proceeds to step 2120 to determine whether the IOPS of those volumes are greater than usual. Whether or not they are larger than usual is determined, for example, by comparing them to a predetermined threshold IOPS. This allows determining whether or not the abnormal behavior is likely to be caused by a virus scan. The determination of step 2120 may also be referred to as the “second determination” for convenience.

If the IOPS of those volumes are less than usual, it is highly likely that the abnormal behavior is caused by virus scanning. Therefore, in this case, the ransomware determination program (cache hit rate perspective) 380 makes a “NO” determination at step 2120 and proceeds to step 2195 to temporarily terminate this processing flow.

If the IOPS of those volumes are larger than usual, it is considered unlikely that the abnormal behavior is due to virus scanning. Therefore, in this case, the ransomware determination program (cache hit rate perspective) 380 makes a “YES” determination at step 2120 and proceeds to step 2125.

The ransomware determination program (cache hit rate perspective) 380 proceeds to step 2125 to determine whether there are any volumes whose cache hit rate has returned to its usual trend, As shown in the description EX22 in FIG. 21B, the ransomware determination program (cache hit rate perspective) 380 determines, for example, whether any of the volumes in LdevId 1, LdevId 4 and LdevId 5 have a cache hit rate that has returned to its usual trend. In other words, among the LdevId 1, LdevId 4, and LdevId 5 volumes, it is determined whether or not there are any volumes whose cache hit rate has returned to its usual trend (no more abnormal behavior is detected). Since data is discarded after data exploitation/theft by ransomware, even if the volume cache hit rate drops, it also does not return to the usual trend. Therefore, by determining whether or not the volume cache hit rate returns to the usual trend after the volume cache hit rate drops, it is possible to determine whether or not the abnormal behavior is caused by ransomware. It should be noted that The determination of step 2125 may also be referred to as the “third determination” for convenience.

If there is a volume whose cache hit rate has returned to its usual trend, it is unlikely that the drop in the cache hit rate is due to the ransomware. Therefore, in this case, the ransomware determination program (cache hit rate perspective) 380 makes a “YES” determination at step 2125 and proceeds to step 2195 to temporarily terminate this processing flow.

If no volume has returned to its usual trend in cache hit rate, there is a strong possibility that the drop in cache hit rate is due to the ransomware. Therefore, in this case, the ransomware determination program (cache hit rate perspective) 380 makes a “NO” determination at step 2125 and proceeds to step 2130.

The ransomware determination program (cache hit rate perspective) 380 proceeds to step 2130 to determine whether the storage system 100 is used by multiple host servers HSV. The determination at step 2130 may also be referred to as the “fourth determination” for convenience.

When the storage system 100 is used by multiple host servers HSV, the ransomware determination program (cache hit rate perspective) 380 makes a “YES” determination at step 2130 and proceeds to step 2135.

The ransomware determination program (cache hit rate perspective) 380 proceeds to step 2135 to determine whether the volumes of other host server HSV(s) have similar cache hit rate trends (whether the abnormal behavior has been detected). As shown in the description EX23 in FIG. 21B, for example, the ransomware determination program (cache hit rate perspective) 380 determines whether the volume of LdevId 2, LdevId 6, and LdevId 3 allocated to other ServerId 102 has the same cache hit rate trend as the cache hit rate of LdevId 1. It should be noted that the determination in step 2135 may also be referred to as the “fifth determination” for convenience.

When the volumes of other host server HSV(s) have similar cache hit rate trends, the ransomware determination program (cache hit rate perspective) 380 makes a “YES” determination at step 2135 and proceeds to step 2140 to detect the abnormal behavior as the ransomware (i.e. detect the abnormal behavior as ransomware-induced behavior (i.e., ransomware-induced unauthorized data access)). Thereafter, the ransomware determination program (cache hit rate perspective) 380 proceeds to step 2195 to temporarily terminate this processing flow.

In contrast, if the volumes of other host server HSV(s) do not show similar cache hit rate trends, the ransomware determination program (cache hit rate perspective) 380 makes a “NO” determination at step 2135 and proceeds to step 2195 to temporarily terminate this processing flow.

When the storage system 100 is not used by multiple host servers HSV at step 2130, the ransomware determination program (cache hit rate perspective) 380 makes a “NO” determination at step 2130 and proceeds to step 2140 to detect the abnormal behavior as the ransomware (i.e., the abnormal behavior is detected as ransomware-caused behavior (unauthorized data access caused by ransomware)). Thereafter, the ransomware determination program (cache hit rate perspective) 380 proceeds to step 2195 to temporarily terminate this processing flow.

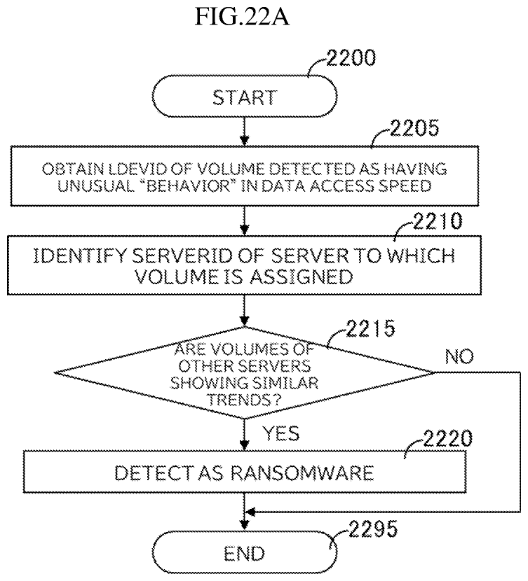

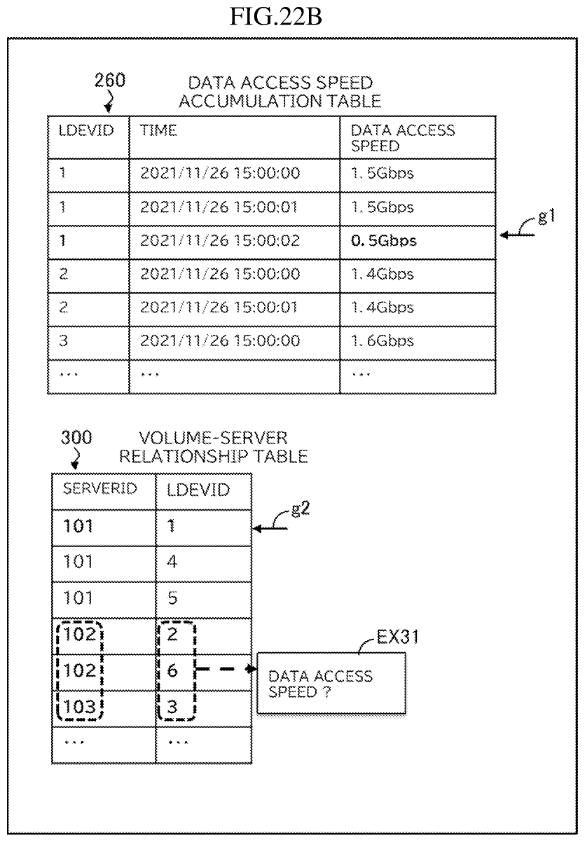

FIG. 22A is a flowchart showing the processing flow executed by the ransomware determination program (data access speed perspective) 390. FIG. 22B is a diagram illustrating a specific example to facilitate understanding of the processing flow in FIG. 22A. The ransomware determination program (data access speed perspective) 390 starts processing from step 2200 and executes steps 2205 and 2210 described below in sequence, and then proceeds to step 2215.

Step 2205: The ransomware determination program (data access speed perspective) 390 obtains the LdevId of the volume for which the abnormal behavior is detected in terms of the speed of accessing data. As shown in FIG. 22B, the ransomware determination program (data access speed perspective) 390, for example, obtains LdevId 1 of the volume in which the abnormal behavior is detected.

Step 2210: The ransomware determination program (data access speed perspective) 390 identifies the ServerId of the host server HSV to which the corresponding volume is assigned by referring to the volume-server relationship table 300. As shown in FIG. 22B, for example, the ransomware determination program (data access speed perspective) 390 identifies ServerId 101 to which the volume of LdevId 1 is allocated from the record indicated by the arrow g2 in the volume-server relationship table 300.

Then, the ransomware determination program (data access speed perspective) 390 proceeds to step 2215 to determine whether the volumes of other host server HSV(s) have a similar trend. As shown in the description EX31, the ransomware determination program (data access speed perspective) 390 determines, for example, whether the data access speeds of LdevId 2 and LdevId 6 assigned to other ServerId 102 and LdevId 3 assigned to other ServerId 103 have the same data access speed trend (that is, the abnormal behavior) as LdevId 1.

When the volumes of other host server HSV(s) have a similar trend, the ransomware determination program (data access speed perspective) 390 makes a “YES” determination at step 2215 and proceeds to step 2220 to detect the abnormal behavior as the ransomware (i.e., the abnormal behavior is behavior caused by the ransomware (i.e., the abnormal behavior is detected as ransomware-induced unauthorized data access)). Thereafter, the ransomware determination program (data access speed perspective) 390 proceeds to step 2295 to terminate this process flow once and for all.

In contrast, when the volumes of other host server HSV(s) are not trending similarly, the ransomware determination program (data access speed perspective) 390 makes a “NO” determination at step 2215 and temporarily terminates this processing flow by proceeding to step 2295.

<Effect>

As explained above, the storage system 100 according to the embodiment of the present invention can detect the ransomware (unauthorized data access by ransomware) at an early stage before data encryption by ransomware. The storage system 100 can detect data theft by ransomware (unauthorized data access at the time of data theft) at the storage layer without using security software, etc. and without depending on the client OS. The storage system 100 can detect unauthorized data access by ransomware with high accuracy by using indicators such as cache hit rate and IOPS specific to the storage system 100 instead of analyzing the data itself, regardless of the contents of the data, and can take security measures. The storage system 100 can detect unauthorized access by ransomware attacks while performing normal operations by constantly monitoring data access trends and comparing them with information on normal patterns accumulated up to now, without relying on prior attack pattern analysis or signatures, and without setting a learning period.

### Modified Example

The present invention is not limited to the above embodiments, and various variations can be employed within the scope of the invention.

(Variation 1)

In the above embodiment, the “ransomware determination” may be omitted, and when the abnormal behavior is detected, the abnormal behavior is detected as unauthorized access caused by ransomware, and the “unauthorized access response process” is executed.

(Variation 2)

In the above embodiment, the abnormal behavior may be detected by executing any one or two of the abnormal behavior detection processes 1 through 3.

(Variation 3)

In the above embodiment, any one of the threshold feedback and monitoring interval feedback may be performed.

(Variation 4)

In the above embodiment, threshold feedback and monitoring interval feedback may be omitted.

(Variation 5)

In the above embodiment, any one of (ransomware determination check (cache hit rate perspective) and ransomware determination check (data access speed perspective)) may be performed.

(Variation 6)

In the above embodiment, steps 2130 and 2135 of FIG. 21A may be omitted.

What is claimed is:

1. A storage system including a controller and a cache that caches data, the storage system providing multiple volumes to one or more computers,
wherein
the controller is configured to execute an abnormal behavior detection process including at least one of:
a first abnormal behavior detection process that obtains a first parameter based on a cache hit rate of the volume within a predetermined sampling interval and detects that the first parameter is smaller than a first threshold parameter as an abnormal behavior;
a second abnormal behavior detection process that obtains a second parameter based on a server cache occupancy rate of the server associated with the volume within the predetermined sampling interval and detects that the second parameter is greater than a second threshold parameter as the abnormal behavior; and
a third abnormal behavior detection process that obtains a third parameter based on a data access speed of the volume within the predetermined sampling interval and detects that the third parameter is smaller than a third threshold parameter as the abnormal behavior.

2. The storage system according to claim 1,
wherein
the controller is configured to execute the abnormal behavior detection process including all of the first abnormal behavior detection process, the second abnormal behavior detection process, and the third abnormal behavior detection process.

3. The storage system according to claim 2,
wherein
the controller is configured to:
execute, when the abnormal behavior is detected by the abnormal behavior detection process, a ransomware determination that determines whether or not the abnormal behavior is caused by ransomware;
determine, as the ransomware determination, whether or not the abnormal behavior is caused by the ransomware based on the behavior of other volumes other than the volume for which the abnormal behavior was detected by at least one of the first abnormal behavior detection process and the second abnormal behavior detection process; and
detect, when it is determined that the abnormal behavior is caused by the ransomware by the ransomware determination, the abnormal behavior as unauthorized data access by the ransomware.

4. The storage system according to claim 3,
wherein
the controller is configured to:
execute, as the ransomware determination, a first determination, a second determination, and a third determination, the first determination identifying the computer to which the volume to which the abnormal behavior was detected is allocated and determining whether or not there is another volume allocated to the identified computer other than the volume to which the abnormal behavior was detected and having the same abnormal behavior, the second determination determining, when the other volume to which the abnormal behavior was detected and having the same abnormal behavior is present, whether or not IOPS of the volume and the other volume for which the abnormal behavior is detected is greater than a predetermined threshold IOPS, the third determination determining, when the second determination that the IOPS of the volume and the other volume for which the abnormal behavior is detected is greater than the predetermined threshold IOPS, whether or not there is a volume among the volume and the other volume for which the abnormal behavior is detected for which the abnormal behavior is resolved; and
detect, when it is determined that there is no volume for which the abnormal behavior has been resolved, the abnormal behavior as the unauthorized data access by the ransomware.

5. The storage system according to claim 4,
wherein
the controller is configured to:
execute, when it is determined by the third determination that there is a volume in which the abnormal behavior has been resolved among the volume and the other volume in which the abnormal behavior has been detected, a fourth determination that determines whether or not there is another computer using the storage system other than the identified computer;
execute, when there is another computer using the storage system other than the computer identified by the fourth determination, a fifth determination that determines whether or not the volume allocated to the other computer also has the same abnormal behavior; and
detect, when it is determined that the volume allocated to the other computer has the same abnormal behavior by the fifth determination, the abnormal behavior as the unauthorized data access by the ransomware.

6. The storage system according to claim 3,
wherein
the controller is configured to:
identify, when the first abnormal behavior detection process detects the abnormal behavior, the computer to which the volume to which the abnormal behavior was detected is allocated; and
detect, when the third parameter based on the data access speed of the volume of another computer other than the identified computer is determined to be smaller than the third threshold parameter, the abnormal behavior as the unauthorized data access by the ransomware.

7. The storage system according to claim 1,
wherein
the controller is configured to:
obtain past data including:
the cache hit rate of the volume;
the cache occupancy rate of the volume; and
the data access speed of the volume; and
execute a threshold feedback process that updates the first threshold parameter, a calculation parameter for the second threshold parameter, and the third threshold parameter based on the past data.

8. The storage system according to claim 7,
wherein
the controller is configured to:
obtain a first parameter based on the cache hit rate of the volume within the sampling interval for each monitoring interval for the past data to set a minimum value of the obtained first parameter as the first threshold parameter;
obtain, a parameter for calculating the second parameter based on the cache occupancy rate of the volume within the sampling interval for each monitoring interval for the past data to set a maximum value of the parameter for calculating the second parameter obtained as the calculation parameter for the second threshold parameter; and
obtain, for the past data, a third parameter based on the data access speed of the volume within the sampling interval for each monitoring interval to set a minimum value of the obtained third parameter as the third threshold parameter.

9. The storage system according to claim 8,
wherein
the controller is configured to execute a monitoring interval feedback process that sets, a period between a first time point and a second time point that shows the same data change trend as the first time point, as the monitoring interval based on the past data.

10. The storage system according to claim 1,
wherein
the controller is configured to:
calculate a slope, an area, or an average value of the cache hit rate of the volume within the predetermined sampling interval as the first parameter;
calculate a slope, an area, or an average value of the cache occupancy of the volume within the predetermined sampling interval as the parameter for calculating the second parameter, and
calculate a slope, an area, or an average value of the data access speed of the volume within the predetermined sampling interval as the third parameter.

11. The storage system according to claim 3,
wherein
the controller is configured to execute, when the abnormal behavior is detected as the unauthorized data access by the ransomware, an unauthorized access response process that responds to the unauthorized data access.

12. The storage system according to claim 11,
wherein
the controller is configured to execute, as the unauthorized access response process, a process that identifies the computer that had the unauthorized data access and disconnects a path to the volume for the identified computer.

13. The storage system according to claim 11,
wherein
the controller is configured to execute, as the unauthorized access response process, a notification process that notifies a user's terminal that the unauthorized data access has occurred; and at least one of:
a process for reducing an amount of data transferred to the computer; and
a process for reducing a transfer rate of data in the storage system.

14. A method for detecting unauthorized access in a storage system that includes a controller and a cache that caches data and provides multiple volumes to one or more computers, the method being executed by the controlled,
the method including:
executing an abnormal behavior detection including at least one of:
a first abnormal behavior detection that obtains a first parameter based on the cache hit rate of the volume within a predetermined sampling interval and detects that the first parameter is smaller than a first threshold parameter as an abnormal behavior;
a second abnormal behavior detection that obtains a second parameter based on the server cache occupancy rate of the server associated with the volume within the predetermined sampling interval and detects that the second parameter is greater than a second threshold parameter as the abnormal behavior; and
a third abnormal behavior detection that obtains a third parameter based on the data access speed of the volume within the predetermined sampling interval and detects that the third parameter is smaller than a third threshold parameter as the abnormal behavior.
